(19) United States
(12) Patent Application Publication
(10) Pub. No.: US 2026/0180844 A1
(43) Pub. Date: Jun. 25, 2026

(54) PAPR REDUCTION FOR MIMO TRANSMISSION

(71) Applicant: Telefonaktiebolaget LM Ericsson (publ), Stockholm (SE)

(72) Inventors: Milad FOZOONI, Göteborg (SE); Petter ERSBO, Knivsta (SE); Karl WERNER, Segeltorp (SE)

(21) Appl. No.: 19/121,418

(22) PCT Filed: Oct. 18, 2022
(86) PCT No.: PCT/EP2022/078997

§ 371 Date: Apr. 15, 2025

(51) Int. Cl. H04L 27/26; H04B 7/0456

(52) U.S. Cl. CPC H04L 27/2615; H04B 7/0456

(57) ABSTRACT

A method is disclosed for reduction of peak-to-average power ratio (PAPR) of transmission of a multiple-input multiple-output (MIMO) signal from a transmitter, wherein the transmission comprises a number of MIMO layers. The method comprises determining a clipping signal for the MIMO signal, and generating a PAPR reduced MIMO signal for transmission by combining the MIMO signal with a projection of the clipping signal onto a null space of an effective channel. The effective channel comprises a propagation channel between the transmitter and one or more receivers (wherein the receivers have an amount of receiver antenna ports) as affected by receiver combining matching transmitter precoding. A setting of the transmitter precoding is varied over frequency, which induces frequency selectivity of the effective channel. The method is particularly useful when the propagation channel is relatively flat in frequency. Corresponding computer program product, apparatus, radio access node, user device, control node, and system are also disclosed.

### TECHNICAL FIELD

The present disclosure relates generally to the field of wireless communication. More particularly, it relates to reduction of peak-to-average power ratio (PAPR) for multiple-input multiple-output (MIMO) transmissions.

### BACKGROUND

Multiple-input multiple-output (MIMO) transmission is well known in the art of wireless communication. For example, fifth generation (5G) wireless communication systems applies MIMO (more particularly massive-MIMO) to enable high spectral efficiency.

Application of massive-MIMO is closely related to radio access node implementation. For example, a large number of antenna elements is typically required for massive-MIMO, which may entail an equally large number of transceiver chains (at least for digital beamforming).

A large number of transceiver chains may be associated with complexity challenges. For example, hardware size can be unacceptable large and/or power consumption can become unacceptably high. These problems may, at least to some extent, be due to high peak-to-average power ratio (PAPR).

Many systems employ orthogonal frequency division multiplexing (OFDM). A drawback of OFDM is that the OFDM signal may, typically, have relatively high PAPR.

One approach to addressing these problems is application of PAPR reduction. PAPR reduction may be implemented by PAPR reduction precoding—also known as massive-MIMO crest factor reduction (CFR). Such techniques enable reduction of the dynamic range of the signal intended for transmission (e.g., an OFDM signal) by taking advantage of the large number of degrees of freedom that are typically available in massive-MIMO systems.

The ability to achieve a sufficiently low PAPR provides several advantages. For example, a sufficiently low PAPR may render digital pre-distortion (DPD) unnecessary, or provide for relatively low DPD complexity. Alternatively or additionally, a sufficiently low PAPR may enable use of relatively small power amplifiers (PAs), and/or PAs with relatively low power consumption. Yet alternatively or additionally, a sufficiently low PAPR may enable use of relatively small cooling sub-systems. Yet alternatively or additionally, a sufficiently low PAPR may enable use of data converters with relatively low resolution.

One precoding approach for PAPR reduction is called convex reduction of amplitudes (CRAM). For example, WO 2019/069117 A1 describes PAPR reduction in a massive-MIMO OFDM transmitter system, including processing of frequency-domain precoded signals in accordance with a multi-carrier CRAM processing scheme.

A problem with these approaches is that the PAPR reduction provided is insufficient, or even non-existent, in some scenarios.

Therefore, there is a need for alternative approaches to PAPR reduction for MIMO transmission.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method for reduction of peak-to-average power ratio (PAPR) of transmission of a multiple-input multiple-output (MIMO) signal from a transmitter, wherein the transmission comprises a number of MIMO layers. The method comprises determining a clipping signal for the MIMO signal, and generating a PAPR reduced MIMO signal for transmission by combining the MIMO signal with a projection of the clipping signal onto a null space of an effective channel. The effective channel comprises a propagation channel between the transmitter and one or more receivers as affected by receiver combining matching transmitter precoding. The receivers have an amount of receiver antenna ports. A setting of the transmitter precoding is varied over frequency.

In some embodiments, the projection of the clipping signal is a projection onto the null space of the effective channel in each sub-carrier.

In some embodiments, the setting of the transmitter precoding being varied over frequency induces frequency selectivity of the effective channel.

In some embodiments, the setting of the transmitter precoding is varied over frequency independently of a frequency profile of the propagation channel.

In some embodiments, a frequency interval between setting variations of the transmitter precoding is fixed, semi-established, or dynamically changing.

In some embodiments, the frequency interval between setting variations of the transmitter precoding is shorter than a threshold value.

In some embodiments, the frequency interval between setting variations of the transmitter precoding is an integer multiple of a system frequency unit.

In some embodiments, the system frequency unit is a physical resource block (PRB) or a sub-carrier bandwidth for orthogonal frequency division multiplex (OFDM).

In some embodiments, the frequency interval between setting variations of the transmitter precoding decreases when magnitude variance between frequencies of the propagation channel decreases.

In some embodiments, the method further comprises transmitting the PAPR reduced MIMO signal over the propagation channel using the setting of the transmitter precoding.

In some embodiments, the method further comprises determining the setting of the transmitter precoding.

In some embodiments, a precoding basis spans a precoding space for the propagation channel, the precoding basis comprising a plurality of precoding basis components, and determining the setting of the transmitter precoding comprises letting the setting of the transmitter precoding be a linear combination of the precoding basis components.

In some embodiments, varying the setting of the transmitter precoding comprises changing coefficient values for the linear combination of the precoding basis components.

In some embodiments, the plurality of precoding basis components is larger than the number of MIMO layers and less than, or equal to, the amount of receiver antenna ports.

In some embodiments, determining the setting of the transmitter precoding further comprises determining the precoding basis.

In some embodiments, determining the precoding basis comprises one or more of: letting the plurality of precoding basis components correspond to a plurality of strongest paths of the propagation channel, letting the plurality of precoding basis components correspond to a plurality of dominant modes of the propagation channel, letting the plurality of precoding basis components correspond to a plurality of singular vectors—with highest singular values—of the propagation channel, and letting the plurality of precoding basis components correspond to a plurality of eigenvectors of the propagation channel correlation matrix with highest eigenvalues.

In some embodiments, determining the setting of the transmitter precoding further comprises weighting the setting of the transmitter precoding by letting an average usage of one of the precoding basis components be associated with the relative strength of a corresponding propagation channel component.

In some embodiments, a sequence used for varying the settings of the transmitter precoding over frequency comprises one or more of: a pre-defined sequence, a pseudo-random sequence generated based on a seed value, a sequence provided to corresponding receiver, and a sequence negotiated with corresponding receiver.

In some embodiments, the method is executed only when the number of MIMO layers for the transmission is lower than the amount of receiver antenna ports.

In some embodiments, the method is executed only when the propagation channel fulfills a frequency flatness condition.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus for reduction of peak-to-average power ratio (PAPR) of transmission of a multiple-input multiple-output, MIMO, signal from a transmitter, wherein the transmission comprises a number of MIMO layers. The apparatus comprises controlling circuitry configured to cause determination of a clipping signal for the MIMO signal, and generation of a PAPR reduced MIMO signal for transmission by combination of the MIMO signal with a projection of the clipping signal onto a null space of an effective channel. The effective channel comprises a propagation channel between the transmitter and one or more receivers as affected by receiver combining matching transmitter precoding.

The receivers have an amount of receiver antenna ports. A setting of the transmitter precoding varies over frequency.

A fourth aspect is a radio access node comprising the apparatus of the third aspect.

A fifth aspect is a user device comprising the apparatus of the third aspect.

A sixth aspect is a control node comprising the apparatus of the third aspect.

A seventh aspect is a system comprising a radio access node and a control node according to the sixth aspect, wherein the control node is configured to control the radio access node for PAPR reduction of transmission of a MIMO signal from a transmitter of the radio access node.

In some embodiments, any of the above aspects may additionally have features identical with or corresponding to any of the various features as explained above for any of the other aspects.

An advantage of some embodiments is that alternative approaches to PAPR reduction for MIMO transmission are provided.

An advantage of some embodiments is that PAPR reduction is provided to a higher degree compared to other approaches.

An advantage of some embodiments is that PAPR reduction is provided without substantial degradation of the error vector magnitude (EVM) for the transmission.

An advantage of some embodiments is that the PAPR reduction performance of massive-MIMO CFR under frequency-flat fading channel conditions is improved compared to conventional approaches (which typically fail to reduce the PAPR sufficiently, or at all, in such channel conditions; and sometimes even worsen the PAPR).

An advantage of some embodiments is that the presented approaches can be used also for spatially rich channels. Then, the PAPR may be reduced more than what is possible with conventional approaches of massive-MIMO CFR.

An advantage of some embodiments is that detrimental effects of the clipping noise on the performance of the intended receiver(s) may be reduced compared to other approaches.

An advantage of some embodiments is that the clipping noise can be suitably separated from the desired signal. For example, the clipping noise can be handled via redundant receiver antenna ports.

An advantage of some embodiments is that clipping noise in other directions than towards the intended receiver(s) may be reduced compared to other approaches.

An advantage of some embodiments is that power efficiency may be improved compared to other approaches.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIGS. 2A-B are a collection of schematic drawings illustrating example principles according to some embodiments;

FIG. 3 is a schematic block diagram illustrating an example end-to-end communication according to some embodiments;

FIG. 4 is a schematic block diagram illustrating an example arrangement according to some embodiments;

FIG. 5 is a schematic block diagram illustrating an example apparatus according to some embodiments;

FIG. 6 is a schematic block diagram illustrating an example system according to some embodiments; and

FIG. 7 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, embodiments will be described wherein alternative approaches to PAPR reduction for MIMO transmission are provided.

As already mentioned, a problem with existing approaches to PAPR reduction for MIMO transmission is that the PAPR reduction provided is insufficient, or even non-existent, in some scenarios. For example, when the channel conditions provide frequency-flat fading and/or a relatively low number of degrees of freedom (e.g., a relatively low number of signal paths and/or a relatively low number of beamformed transmission directions; one example being channels dominated by line-of-sight—LoS), PAPR reduction may be insufficient when existing approaches are applied.

To address insufficient PAPR reduction, some embodiments consider an effective channel comprising the propagation channel as affected by receiver combining matching the transmitter precoding. The setting of the transmitter precoding is varied over frequency, which may be seen as inducing (creating, emulating) frequency selectivity of the effective channel. Thus, artificial frequency selectivity is added to (introduced into) the effective channel by varying the setting of the transmitter precoding over frequency. Thereby, the effective channel does not suffer from PAPR reduction problems in the same way as frequency-flat channels. Particularly, the frequency-varying transmitter precoder setting provides suitable conditions for a null space of the effective channel that is well suited for carrying a clipping signal used for PAPR reduction. For example, the frequency-varying transmitter precoder setting may provide suitable conditions for a null space of the effective channel in each sub-carrier, which makes the null spaces suitable for carrying a clipping signal to reduce the PAPR.

For example, for sub-carrier n, when a vector sₙ denotes the data layers transmitted, the propagation channel is denoted by Hₙ, and Pₙ and Wₙ denote—respectively—precoder matrix at the transmitter for sub-carrier n and receiver combining weights, a receiver processing result in absence of the noise may be expressed as ŝₙ=WₙHₙPₙsₙ. A possible effective channel may be defined as WₙHₙPₙ (representable as an L×L—square—matrix, where L is the number of data layers). However, such an effective channel has an empty null-space and is typically not helpful in the context addressed herein. Thus, according to some embodiments, the effective channel is defined as Wₙ Hₙ (the propagation channel as affected by receiver combining). This effective channel is representable by a L×M—rectangular—matrix (where M is the number of transmitter antenna ports), and has a non-empty null space with at least M−L independent basis components.

It should be noted that, varying/changing the precoder Pₙ over frequency, typically causes the combiner Wₙ to (automatically) be varied/changed accordingly over frequency (receiver combining matching the transmitter precoding); aiming to receive maximum signal-to-noise-ratio (SNR; or any other suitable quality metric). Hence, the effective channel WₙHₙ will be varied/changed over frequency and behave like a frequency-selective channel. Thus, the precoder Pₙ is typically not part of the effective channel, but implicitly impacts the effective channel through the combining weights at the receiver side Wₙ.

The clipping signal typically provides PAPR reduction, but it may also increase the error vector magnitude (EVM) if not separable from the desired signal. It is beneficial to let a channel null space carry the clipping signal, since this renders the clipping signal separable from the desired signal at the receiver(s).

Thus, some embodiments provide approaches that assist massive-MIMO CFR algorithms to perform well under frequency-flat fading channel conditions; a scenario where conventional massive-MIMO CFR algorithms typically fail to reduce PAPR sufficiently (or at all), and may even increase the PAPR in some situations.

According to some embodiments, the presented approaches can also be used with spatially rich channels; whereby PAPR may be reduced further than what is possible with conventional massive-MIMO CFR algorithms.

Generally, when a radio access node is referred to herein, it is meant to include any suitable node for providing communication radio access. For example, a radio access node may be a base station, a gNodeB, an open radio access network (O-RAN) radio unit (O-RU), an access point (AP), etc.

Also generally, when a user device is referred to herein, it is meant to include any suitable wireless communication device for a user. For example, a user device may be a user equipment (UE), a station (STA), etc.

Also generally, when control node is referred to herein, it is meant to include any suitable node for communication control. For example, a control node may be a central network node, a cloud server, an edge computing node, etc.

Furthermore, it should be noted that embodiments may be equally relevant for any communication context where PAPR reduction and MIMO transmission is applied. For example, embodiments may be applicable in relation to any suitable radio access approach (e.g., communication according to IEEE 802.11, according to standardization as advocated by the Third Generation Partnership Project, 3GPP, etc.). Alternatively or additionally, embodiments may be applicable in relation to any suitable channel conditions (e.g., line-of-sight—LoS—conditions, frequency-flat fading conditions, multi-path channel conditions, etc.).

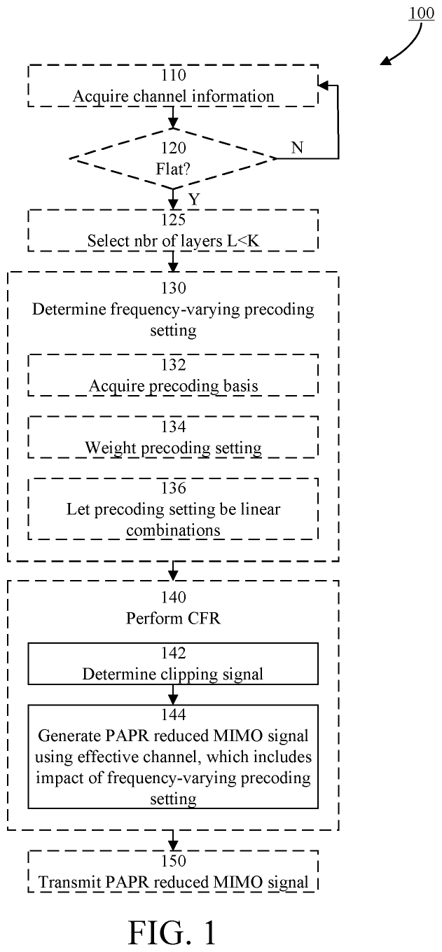

FIG. 1 illustrates an example method 100 according to some embodiments. The method 100 is for reduction of peak-to-average power ratio (PAPR) of transmission using multiple-input multiple-output (MIMO) from a transmitter. In some embodiments, the method 100 may be performed by a communication device that comprises the transmitter (e.g., a radio access node or a user device). In some embodiments, at least part of the method 100 may be performed by a communication device that does not comprise the transmitter (e.g., a control node).

The method 100 comprises determining a clipping signal for the MIMO signal, as illustrated by sub-step 142, and generating a PAPR reduced MIMO signal for transmission by combining the MIMO signal with a projection of the clipping signal onto a null space of an effective channel, as illustrated by sub-step 144. In some embodiments, the PAPR reduced MIMO signal consists of the MIMO signal and the projection of the clipping signal onto the null space of the effective channel.

As illustrated by optional step 140 incorporating sub-steps 142 and 144, the determination of the clipping signal and the generation of the PAPR reduced MIMO signal may, for example, be implemented using any suitable crest-factor reduction (CFR) approach (e.g., CRAM).

For example, determination of the clipping signal may be achieved using polar clipping, or any other suitable clipping approach. Alternatively or additionally, the clipping signal may be achieved using hard clipping, soft clipping, donut clipping (clipping from above and below), or any other suitable clipping approach.

Typically, a maximal magnitude of the clipping signal (a.k.a., a clipping threshold) may be used as a limiting condition in the determination of the clipping signal. The maximal magnitude of the clipping signal may be fixed or variable. In some embodiments, the maximal magnitude of the clipping signal increases with frequency flatness of the channel. For example, the maximal magnitude of the clipping signal may increase when magnitude variance between frequencies of the MIMO channel decreases. This may enable dynamic trade-off between PAPR reduction performance and drawbacks due to PAPR reduction (e.g., transmission power allocated to virtual receiver(s) and/or EVM for the intended receiver(s) due to leakage).

More generally, the determination of the clipping signal in 142 and the generation of the PAPR reduced MIMO signal in 144 may be performed according to any suitable approach (e.g., CFR and/or PAPR approaches of the prior art), while using the null space of the effective channel—instead of the propagation channel—for projection of the clipping signal.

The effective channel comprises a propagation channel between the transmitter and one or more receivers, as affected by receiver combining matching the transmitter precoding.

A setting of the transmitter precoding is varied over frequency, which may be seen as a way to induce frequency selectivity of the effective channel. Thus, the effective channel includes an impact of the frequency-varying precoding setting. Thereby, the MIMO channel is richened (e.g., in terms of number of degrees of freedom) by introduction, or increase, of frequency selectivity.

To this end, the method 100 is particularly suitable for propagation channel conditions with relatively flat fading (e.g., as LoS conditions); but application of the method 100 is not limited thereto.

Generally, non-linear operation is beneficial for PAPR reduction (e.g., in massive-MIMO CFR) because the non-linearity enables spreading of clipping noise in the null space (as well as in different directions). In a frequency flat scenario (e.g., in LOS conditions), the clipping operation is reduced to a linear operation, which entails that it is not possible to properly spread the clipping noise. Using an effective channel, which includes an impact of frequency-varying precoding settings, may cause the clipping to behave nonlinearly.

Put differently, using an effective channel which includes an impact of frequency-varying precoding settings, provides suitable conditions for a null space (e.g., a null space in each sub-carrier) with improved ability (compared to other approaches) to carry the clipping signal. For example, the null space of the effective channel may entail that a portion of the clipping signal that it is possible to divert from a main beam (thereby “hiding” it from the receiver) is larger than for the null space of the propagation channel.

Typically, two conditions need to be simultaneously satisfied for CFR; a null space for projection of the clipping noise, and frequency-selectivity for diversion of the clipped noise from the main beam. When the propagation channel—which typically has a null space that can be used for projection—is not (sufficiently) frequency-selective, the projected clipping noise will appear at the receiver(s). This is solved by some embodiments by varying the transmitter precoding over frequency, which introduces frequency-selectivity into the effective channel via the receiver combining, thereby enabling the clipping noise to be diverted from main beam(s) (thereby “hiding” it from the receiver(s).

In typical embodiments, the setting of the transmitter precoding is varied over frequency independently of a frequency profile of the propagation channel. Thus, the frequency profile of the propagation channel (whether flat or frequency selective) may be disregarded when the frequency-varying setting of the transmitter precoding is determined.

In some embodiments, the frequency profile of the propagation channel may, at least to some extent, be used as an input when the frequency-varying setting of the transmitter precoding is determined, as will be exemplified later herein.

Generally, it may be noted that the frequency-varying setting of the transmitter precoding is typically not (at least not primarily) intended to follow frequency variations of the propagation channel; but rather to induce frequency selectivity of the effective channel.

The frequency interval between setting variations of the transmitter precoding may be fixed, semi-established (e.g., fixed for some period of time, for a particular communication session, until some specific event occurs, etc.), or dynamically changing (e.g., based on changes in the propagation channel).

The frequency interval between setting variations of the transmitter precoding may be negotiated between transmitter and receiver(s), or the frequency-varying setting of the transmitter precoding may be transparent to the receiver(s).

In some embodiments, the frequency interval between setting variations of the transmitter precoding is shorter than a threshold value. For example, the threshold may define a largest frequency interval that provides suitable conditions for null space of the propagation channel.

In some embodiments, the frequency interval between setting variations of the transmitter precoding is an integer multiple (including unit multiple) of a system frequency unit. For example, the system frequency unit may be a physical resource block (PRB) or a sub-carrier bandwidth for OFDM. Using an integer multiple of a system frequency unit may have the benefit of providing the frequency-varying setting of the transmitter precoding as transparent to the receiver(s). For example, according to Third Generation Partnership Project (3GPP) technical specifications, frequency selectivity is already handled by the receiver with a granularity of 2 or 4 PRBs (24 or 48 sub-carriers). Hence, if the frequency interval between setting variations of the transmitter precoding is set to these values, no specific mechanism is required at the receiver(s) to accommodate these variations of the transmitter precoding.

In some embodiments, the frequency interval between setting variations of the transmitter precoding decreases when magnitude variance between frequencies of the propagation channel decreases. Thus, the frequency interval between setting variations of the transmitter precoding decreases with frequency flatness of the channel.

It should be understood that any suitable combination of the described features for the frequency interval between setting variations of the transmitter precoding is also possible.

As illustrated by optional step 150, the method 100 may further comprise transmitting the PAPR reduced MIMO signal over the propagation channel using the setting of the transmitter precoding. Generally, the MIMO transmission may comprise transmission of an OFDM signal. For example, at least the desired signal may be an OFDM signal. Alternatively or additionally, the clipping signal, and/or its projection, may be an OFDM signal.

In some embodiments, the method 100 is executed only when the number, L, of MIMO layers for the transmission is lower than the amount, K, of receiver antenna ports. With a higher number of MIMO layers, the possibilities to provide suitable conditions for the null space are more limited (or non-existent).

This is illustrated by optional step 125, wherein the number of MIMO layers is selected as being less than the amount of receiver antenna ports.

Alternatively, the number, L, of MIMO layers may be selected without this constraint and 125 may be replaced by a condition. Thus, the remainder of the method 100 is executed only when L<K. Otherwise, a conventional massive-MIMO CFR approach may be applied; for example.

In some embodiments, using the effective channel for null space projection and/or letting the effective channel have characteristics that result from frequency-varying precoding setting is applied only when the MIMO propagation channel fulfills a frequency flatness condition (e.g., defining a condition for frequency-flat fading). This is illustrated by optional steps 110 and 120 in FIG. 1.

It should be noted, however, that—according to some embodiments—an effective channel with characteristics that result from frequency-varying precoding setting is used for null space projection also in situations when the MIMO propagation channel is not frequency flat (e.g., does not fulfill the frequency flatness condition). This may improve the PAPR reduction and/or the EVM compared to using the MIMO propagation channel for projection.

In step 110, channel information is acquired (e.g., by performing channel measurements, and/or receiving channel measurement report(s) from the intended receiver(s)). In step 120, it is determined whether the frequency flatness condition is fulfilled.

When the frequency flatness condition is fulfilled (Y-path out of step 120) the remainder of the method 100 is executed. When the frequency flatness condition is not fulfilled (N-path out of step 120) the remainder of the method 100 is not executed, which is illustrated in FIG. 1 by a return path to step 110. Although not shown in FIG. 1, it should be understood that other actions may be performed when the frequency flatness condition is not fulfilled. For example, a conventional massive-MIMO CFR approach may be applied for MIMO transmission.

The frequency flatness condition may comprise any suitable condition. For example, a frequency flatness metric may be compared to a threshold value. Then, the frequency flatness condition may be fulfilled when the frequency flatness metric falls on a first side of the threshold value that corresponds to relatively flat channels (e.g., when the frequency flatness metric does not exceed the threshold value), and the frequency flatness condition may be not fulfilled when the frequency flatness metric falls on a second side of the threshold value that does not correspond to relatively flat channels (e.g., when the frequency flatness metric exceeds the threshold value). An example frequency flatness metric may be, or may be based on, a magnitude and/or phase variance between frequencies for the channel.

Acquisition of channel information as illustrated by step 110 may, alternatively or additionally, be relevant for other purposes than switching on and off the use of the effective channel with characteristics that result from frequency-varying precoding settings for null space projection according to step 120. For example, as will be exemplified in the following, the channel information may be used to determine what the frequency-varying precoding setting should be.

Typically, the transmitter precoding may be updated when new channel information (e.g., channel state information, CSI) becomes available in step 110. This transmitter precoding update may, in some embodiments, be seen as separate from the process of using frequency-varying settings for the transmitter precoding.

For illustration, a first intermediate precoding matrix may represent default transmitter precoding (e.g., updating when new channel information is available), and a second intermediate precoding matrix may represent the frequency-variation to induce frequency selectivity (which may be static or dynamic over time). Then, the transmitter precoding may be represented by a combination of (multiplication between) the first and second intermediate precoding matrices.

In some embodiments, the method 100 comprises determining the frequency-varying setting of the transmitter precoding, as illustrated by optional step 130.

As illustrated by optional sub-step 132, the determination of the frequency-varying setting of the transmitter precoding may comprise acquiring a precoding basis, which spans a precoding space for the propagation channel. In some embodiments, sub-step 132 comprises determining the precoding basis.

In some embodiments, sub-step 132 comprises retrieving a pre-computed precoding basis. For example, the channel may be estimated at any suitable times (e.g., using uplink pilots such as sounding reference signals, SRS), and the eigenvectors of the estimated channel correlation matrix may be determined in connection thereto; to be utilized until the channel is estimated again.

Generally, the precoding basis comprises a plurality of (at least two) precoding basis components (e.g., represented as basis vectors). Typically, the number of basis components is related to the number, K, of receiver ports. For example, the number of basis components may be at most equal to the amount, K, of receiver antenna ports (since this correspond to fully spanning the potential space). Alternatively or additionally, the number of basis components may be larger than the number, L, of MIMO layers of the transmission (since this corresponds to a lower limit for achieving frequency variation). The latter is in contrast to other approaches, where the number of used precoding basis components is normally equal to the number, L, of MIMO layers of the transmission. In some typical embodiments, the number, L, of MIMO layers of the transmission is lower than the number, K, of receiver ports (e.g., since this corresponds to achieving a non-empty null-space; based on a combiner receiver).

The precoding basis may comprise any suitable spanning of the precoding space, and may be determined according to any suitable approach. For example, the plurality of precoding basis components may correspond to one or more of: a plurality of strongest paths of the propagation channel, a plurality of dominant modes of the propagation channel, a plurality of singular vectors—with highest singular values—of the propagation channel, a plurality of eigenvectors/eigenmodes of the propagation channel correlation matrix with highest eigenvalues, a plurality of components according to precoding matrix indicator (PMI) provided as feedback from the receiver(s), and discrete Fourier transform (DFT) vectors or inverse DFT (IDFT) vectors.

In a typical example, each precoding basis is represented by a vector of size M×1, where M is the number of transmitter ports.

It should be noted that the precoding basis may be represented by a second intermediate precoding matrix (which may be fixed and/or independent of the propagation channel) according to some embodiments.

As illustrated by optional sub-step 136, the determination of the frequency-varying setting of the transmitter precoding may comprise letting the setting of the transmitter precoding be a linear combination of the precoding basis components. Then, frequency-variation of the setting of the transmitter precoding may be achieved by changing coefficient values over frequency for the linear combination of the precoding basis components.

In a typical example, L different precoders are generated using the linear combinations; one precoder per layer. Generally, the precoding basis and/or the linear combinations may be different, or the same, for different layers.

It should be noted that selecting one of the precoding basis components to represent the setting of the transmitter precoding is an example of a linear combination of the precoding basis components; with all coefficients—except one of them—having the coefficient value set to zero. This is termed herein as a trivial linear combination. Other example linear combinations of the precoding basis components include two or more (e.g., all) precoding basis components with non-zero coefficient values. This is termed herein as non-trivial linear combinations.

In some embodiments, all applied linear combinations are trivial linear combinations (i.e., frequency-variation of the setting of the transmitter precoding is achieved by changing which precoding basis component is used). In some embodiments, at least one (e.g., some, or all) applied linear combinations are non-trivial linear combinations.

Typically, the coefficient values have respective magnitudes that fall inclusive between zero and one. In some embodiments, the coefficient values (or their respective magnitudes) are limited to the values zero and one. In some embodiments, one or more coefficient values (or respective magnitudes) between zero and one are available. Generally, the coefficient values may be scalar values or complex values. In some embodiments with complex coefficient values, two or more (e.g., all) coefficients may have the same magnitude value, but different phase values.

In a typical example, the linear combinations are subject to power normalization.

As illustrated by optional sub-step 134, the determination of the frequency-varying setting of the transmitter precoding may comprise weighting (biasing) the setting of the transmitter precoding by letting an average usage of one of the precoding basis components be associated with the relative strength of a corresponding propagation channel component.

To exemplify, a precoding basis component that relates to a strong channel path could preferably be used more often and/or with higher coefficient magnitude than other precoding basis components. In some embodiments, an average over frequency of the squared coefficient value for a precoding basis component be proportional to the power of the related channel component (e.g., channel path).

In some embodiments, a sequence used for varying the settings of the transmitter precoding over frequency (e.g., a sequence of linear combinations) may be a pre-defined sequence, or dynamically selected sequence.

Alternatively or additionally, the sequence used for varying the settings of the transmitter precoding over frequency may be negotiated with (or provided to; e.g., using control signaling) corresponding receiver. In this context, it should be noted that, according to some embodiments, the receiver does not need specific information regarding the variation of the settings of the transmitter precoding over frequency (e.g., when the frequency interval between setting variations of the transmitter precoding in a 3GPP scenario is 2 PRBs, or a multiple thereof). For example, the receiver may be configured (e.g., based on a standardization specification) to follow frequency variations with some granularity (e.g., 2 PRBs). Hence, if the variation of the settings of the transmitter precoding over frequency has the same granularity as the granularity that the receiver is configured to follow (or a lower granularity such that the granularity that the receiver is configured to follow is a multiple of the granularity of the variation of the settings of the transmitter precoding over frequency), the variation of the settings of the transmitter precoding over frequency is handled transparently by the receiver.

In some embodiments, the sequence used for varying the settings of the transmitter precoding over frequency is a pseudo-random sequence (or a portion thereof) generated based on a seed value. In such cases any negotiation with (or provision to) corresponding receiver may relate to the seed value.

As already mentioned, at least part of the method 100 may be performed by a communication device that does not comprise the transmitter (e.g., a control node) according to some embodiments. For example, a control node may perform steps 120-140, and cause a radio access node to perform step 150 (e.g., by providing the PAPR reduced MIMO signal to the radio access node), or a control node may perform step 130, and cause a radio access node to perform steps 140 and 150 (e.g., by providing an indication of the frequency-varying precoding setting to the radio access node).

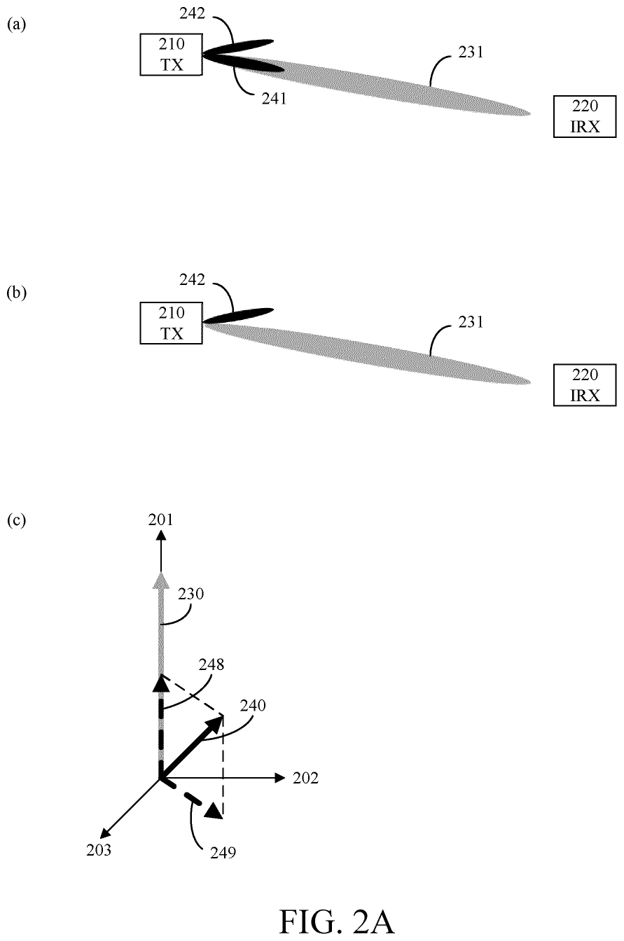

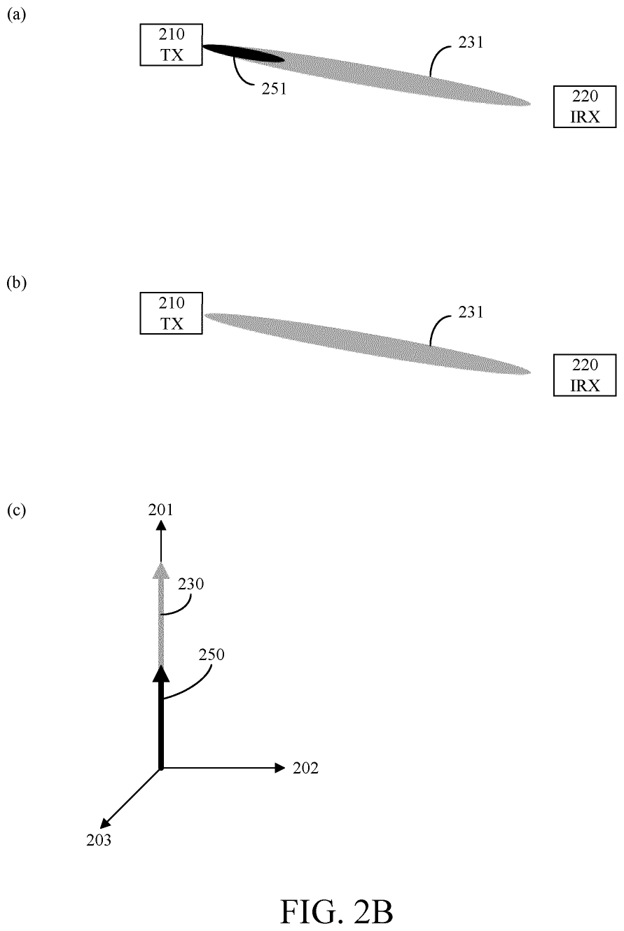

Reference will now be made to FIGS. 2A-B to illustrate scenarios where some embodiments may be beneficial.

As already indicated, massive CFR algorithms (e.g., CRAM) can significantly reduce the PAPR of a signal to be transmitted by taking advantage of the degrees for freedom provided by large antenna arrays. This is typically achieved by determining a clipping signal (a.k.a., clipping noise) for the signal and transmitting the signal together with at least a portion of the clipping signal.

FIGS. 2A-B exemplify how the clipping signal may be handled in two different scenarios for the propagation channel.

Thus, FIGS. 2A-B are a collection of schematic drawings illustrating example principles of PAPR reduction. The example principles are illustrated for a transmitter (TX) 210 and an intended receiver (IRX) 220.

FIG. 2A schematically illustrates example principles of PAPR reduction for a MIMO channel which is relatively rich because there is more than one signal path available for transmission (i.e., more than one possible beamformed transmission direction).

Part (a) of FIG. 2A illustrates a MIMO signal 231 (e.g., Pₙsₙ, where Pₙ is the precoder for sub-carrier n, and sₙ represents the user traffic on sub-carrier n) on a beam directed towards the intended receiver, and a corresponding clipping signal (e.g., represented by zₙ for sub-carrier n) for PAPR reduction of the MIMO signal. The clipping signal comprises two parts 241, 242 on respective beams.

A first part of the clipping signal 241, which is a projection of the clipping signal onto the sub-space of the MIMO channel that the MIMO signal occupies (e.g.,

$${H}_{n}^{†} {H}_{n} {z}_{n} ,$$

where Hₙ is the propagation channel representation for sub-carrier n, and

$${H}_{n}^{†}$$

is the Moore-Penrose inverse thereof), appears on the same beam as the MIMO signal 231. A second part of the clipping signal 242, which is a projection of the clipping signal onto the sub-signal space of the MIMO channel that the MIMO signal does not occupy (e.g.,

$$( I - {H}_{n}^{†} {H}_{n} ) {z}_{n} ,$$

where I is the identity matrix), appears on a different beam than the MIMO signal 231.

Thus, clipped-noise may be seen as having two components (portions/parts) in the frequency-selective channel illustrated by FIG. 2A. One portion (the second part above) is transparent to the intended receiver. This portion can be considered as an auxiliary beam for shaping the signal waveform and reduce PAPR. Another portion (the first part above) resides in the main beam and is visible to the intended receiver.

Thus, it may be beneficial to remove this portion (the first part above) before transmission to lower the EVM at the receiver (e.g., to satisfy some EVM requirements). This is illustrated in part (b) of FIG. 2A.

Thus, part (b) of FIG. 2A illustrates a PAPR reduced MIMO signal for transmission. The PAPR reduced MIMO signal is a combination of the MIMO signal 231 and the second part of the clipping signal 242.

The signal combination of part (a) of FIG. 2A provides high PAPR reduction (due to inclusion of both parts 241, 242 of the clipping signal) but also high EVM for the intended receiver (due to the first part 241 of the clipping signal causing disturbance to the MIMO signal 231).

The signal combination of part (b) of FIG. 2A provides reasonably high PAPR reduction (due to inclusion of the second part 242 of the clipping signal) and no EVM for the intended receiver (due to no part of the clipping signal causing disturbance to the MIMO signal 231).

Thus, the approach exemplified by part (b) or FIG. 2A may be advantageous for transmission. Put more generally, this approach may be described as determining a clipping signal for the MIMO signal and generating a PAPR reduced MIMO signal by combining the MIMO signal with a projection of the clipping signal onto the sub-signal space of the MIMO channel that is not occupied by the MIMO signal.

Part (c) of FIG. 2A illustrates the principles of parts (a) and (b) of FIG. 2A in a schematic representation of the MIMO channel. The schematic representation of the MIMO channel has two dimensions; illustrated in a three-dimensional space spanned by corresponding basis vectors 201, 202, 203. The MIMO signal 231 occupies the dimension spanned by basis vector 201, as illustrated by 230. The clipping signal 240 comprises a first part 241 and a second part 242. The first part 241 is a projection onto the sub-space of the MIMO channel that the MIMO signal occupies, as illustrated by 248. The second part 242 is a projection onto the sub-space of the MIMO channel that the MIMO signal does not occupy, as illustrated by 249. Thus, the MIMO signal 230 and the second part 249 of the clipping signal may be orthogonally transmitted to achieve reasonably high PAPR reduction without any EVM for the intended receiver.

Unfortunately, in flat-fading channels, clipped-noise typically appears entirely in the direction of the intended receiver; i.e., it does not have any component in the null space of the propagation channel. Hence, massive CFR techniques typically cannot benefit from the auxiliary beam to shape the signal waveform for PAPR reduction while keeping EVM at an acceptably low level. One explanation of this problem is that the clipping function is reduced to a linear operator in flat-fading channels, and fails to spread clipped-noise in different directions. The phenomenon is more pronounced for rank-1 transmission.

FIG. 2B schematically illustrates example principles of PAPR reduction for a MIMO channel having only one signal path available for transmission (i.e., only one possible beamformed transmission direction), which may be seen as an exemplification of a frequency-flat channel.

Part (a) of FIG. 2B illustrates a MIMO signal 231 (e.g., Pₙsₙ)) on a beam directed towards the intended receiver, and a corresponding clipping signal (e.g., represented by zₙ) for PAPR reduction of the MIMO signal. Since the MIMO channel has only one signal path available for transmission, the clipping signal consists of one part 251 (which may be seen as a trivial form of projection of the clipping signal onto the sub-space of the MIMO channel that the MIMO signal occupies, e.g.,

$${H}_{n}^{†} {H}_{n} {z}_{n} = {z}_{n} ) ,$$

which appears on the same beam as the MIMO signal 231. A projection of the clipping signal onto the sub-signal space of the MIMO channel that the MIMO signal does not occupy is void (i.e., the clipping signal is projected onto zero, e.g.,

$$( I - {H}_{n}^{†} {H}_{n} ) {z}_{n} = 0 )$$

because there is no clipping energy in that sub-signal space of the MIMO channel.

Part (b) of FIG. 2B illustrates the result of an attempted PAPR reduction of the MIMO signal, wherein the MIMO signal 231 is combined with the (void) projection of the clipping signal onto the sub-signal space of the MIMO channel that the MIMO signal does not occupy.

The signal combination of part (a) of FIG. 2B provides high PAPR reduction (due to inclusion of the clipping signal 251) but also high EVM for the intended receiver (due to the clipping signal 251 causing disturbance to the MIMO signal 231).

The signal combination of part (b) of FIG. 2B provides no PAPR reduction at all (due to the clipping signal being completely removed by projection) and no EVM for the intended receiver (due to no clipping signal causing disturbance to the MIMO signal 231).

Thus, it is problematic to use the advantageous approach of FIG. 2A in the context of non-rich MIMO channels. Some embodiments addresses this issue by application of an effective channel which includes an impact of frequency-varying setting of transmitter precoding. Thereby, the situation of FIG. 2B can be fictionally transformed to the situation of FIG. 2A, and PAPR reduction can be achieved while EVM is kept at a low level.

As already elaborated on above, some embodiments suggest projecting clipped noise onto the null space of the effective end-to-end channel (including the receiver combining weights) rather than the null space of the propagation channel (which only extends to the receiver antenna ports). This, in combination with manipulating the effective channel to induce frequency selectivity, may be beneficial to overcome the problems of PAPR reduction for frequency-flat propagation channels (e.g., as exemplified in FIG. 2B) and/or improve PAPR reduction for any propagation channels. One way of manipulating the effective channel to induce frequency selectivity comprises varying/changing the transmitter precoding in frequency domain (e.g., every few physical PRBs).

FIG. 3 schematically illustrates an example end-to-end communication, which may be relevant in the context of some embodiments.

The end-to-end communication illustration of FIG. 3 includes an input block (IN) 301 representing input symbols sₙ, a baseband precoder block (PC) 302 representing transmitter precoding, a channel block (CH) 303 representing the propagation channel Hₙ, a reception block (RX) 304 representing one or more receiver(s), and a combiner block (COMB) 305 representing reception combining.

For a situation where CFR is not applied, the precoder block 302 could be represented by Pₙsₙ, the reception block 304 could be represented by HₙPₙsₙ (assuming absence of noise), and the combiner block 305 could be represented by ŝₙ=W_{r,n}HₙPₙsₙ, where W_{r,n} represents the combiner of receiver r for sub-carrier n.

For a situation where CFR according to the prior art is applied (assuming perfect channel estimate available at the transmitter), the precoder block 302 could be represented by

$${P}_{n} {s}_{n} + ( I - {H}_{n}^{†} {H}_{n} ) {z}_{n} ,$$

the reception block 304 could be represented by

$${H}_{n} {P}_{n} {s}_{n} + {H}_{n} ( I - {H}_{n}^{†} {H}_{n} ) {z}_{n} = {H}_{n} {P}_{n} {s}_{n} + 0$$

(assuming absence of noise), and the combiner block 305 could be represented by ŝₙ=W_{r,n}HₙPₙsₙ.

For a situation where CFR is applied with projection onto the null space of the effective end-to-end channel, the precoder block 302 could be represented by Pₙsₙ+(I−(W_{t,n}Hₙ)^{†}(W_{t,n}Hₙ))zₙ, where W_{t,n} represents addition of artificial frequency selectivity to the effective end-to-end channel (W_{t,n} may, or may not, also represent partial or full effect of the precoder Pₙ). The reception block 304 could be represented by HₙPₙsₙ+Hₙ(I−(W_{t,n}Hₙ)^{†}(W_{t,n}Hₙ))zₙ (assuming absence of noise), and the combiner block 305 could be represented by ŝₙ=W_{r,n}HₙPₙsₙ+W_{r,n}Hₙ(I−(W_{t,n}Hₙ)^{†}(W_{t,n}Hₙ))zₙ=W_{r,n}HₙPₙsₙ+0. The last term becomes zero since W_{r,n} is configured to aim for maximization of the signal-to-noise-and-distortion ratio (SNDR; or any other suitable quality metric), which is equivalent to adapting itself to the precoder Pₙ and cancel the received clipping noise.

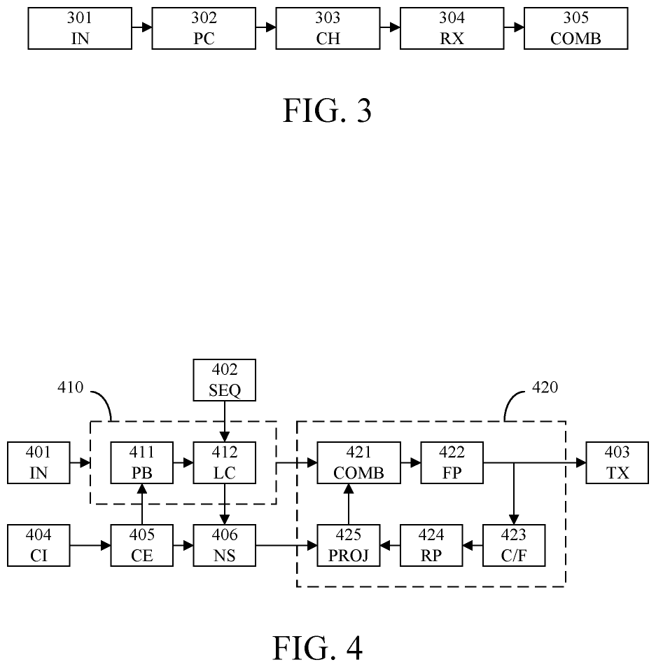

FIG. 4 schematically illustrates an example arrangement according to some embodiments. Input symbols are provided as illustrated by input block (IN) 401 to a precoder 410.

Channel indicators are also provided as illustrated by channel indicator block (CI) 404. For example, the channel indicators may be reference signals (RSs) transmitted by intended receiver(s). Alternatively or additionally, the channel indicators (e.g., channel state information, CSI) may be comprised in channel measurement report(s) from intended receiver(s).

The channel indicators are used to estimate the propagation channel as illustrated by channel estimation block (CE) 405. For example, the channel estimation may comprise channel measurements on the reference signals transmitted by intended receiver(s). Alternatively or additionally, the channel estimation may comprise determination based on channel measurement report indication(s).

Blocks 404 and 405 may be compared with 110 of FIG. 1.

In the precoder 410, the channel estimation is used to determine a precoding basis as illustrated by precoding basis block (PB) 411. The precoding basis has a plurality of precoding components, and spans a precoding space for the propagation channel. As already mentioned, the plurality of precoding basis components is typically larger than the number L of MIMO layers and less than, or equal to, the amount K of receiver antenna ports.

Block 411 may be compared with 132 of FIG. 1.

In the precoder 410, a linear combination of precoding component(s) is applied as illustrated by linear combination block (LC) 412. The linear combination is varied over frequency based on a sequence for combining as illustrated by sequence block (SEQ) 402.

Blocks 412 and 402 may be compared with 130 (especially 136) of FIG. 1.

As illustrated by null space block (NS) 406, the null space of the effective channel is determined from the linear combination of block 412 and the channel estimation of block 405.

The precoded input symbols and the null space are provided to an iterative CRAM 420, which outputs a signal for transmission as illustrated by transmission block (TX) 403.

The iterative CRAM may be compared with 140 of FIG. 1, and block 403 may be compared with 150 of FIG. 1.

The iterative CRAM 420 comprises combination (e.g., addition or superposition) of the precoded signal and a clipping signal as illustrated by combining block (COMB) 421. The combined signal is subjected to forward processing (e.g., inverse fast Fourier transform, IFFT, and prepending of cyclic prefix, CP) as illustrated by forward processing block (FP) 422, before being provided as the output signal.

The clipping signal is based on feedback of the output signal. The feedback path comprises clipping (and usually filtering) the feedback signal as illustrated by clipping and filtering block (C/F) 423. The feedback signal is also subjected to reverse processing (e.g., possible CP removal, and fast Fourier transform, FFT) as illustrated by reverse processing block (RP) 424, and projection onto the null space as illustrated by projection block (PROJ) 425, before being provided as the clipping signal.

Block 423 may be compared with 142 of FIG. 1, and blocks 425 and 421 may be compared with 144 of FIG. 1. Thus, according to some embodiments, clipped-noise is projected onto (virtually hidden in) the null space of an effective channel that includes the effect of receiver combining, while the effective channel is made frequency selective by frequency-domain variations of the precoder.

Typically, the frequency-domain variations may be designed such that the receiver combining automatically changes accordingly. For example, in 3GPP applications, the frequency-domain variations may be designed to have a frequency interval of two PRBs (or a multiple thereof) between changes of the precoder setting to render the approach transparent to the receiver.

According to typical scenarios, the number of data layers (L) should be less than the number of receiver ports (K) to guarantee that a non-empty null space can be provided for the combiner matrix at the receiver side (and thereby enable null space projection).

General principles of some embodiments will now be further elaborated on by exemplification.

In one example, the transmitter will be assumed to be a radio access node in the form of a gNB with M antenna ports and the receiver(s) will be assumed to be a single device in the form of a UE with K=2 antenna ports (vertical and horizontal polarized antennas). The gNB aims to transmit L=1 layers of data (i.e., L<K). The propagation channel is assumed to be flat. As already mentioned, it should be noted that there is no limitation intended hindering extension to frequency-selective channels, and/or other values of K and L.

According to the example, the gNB retrieves channel information by estimating the channel based on RSs transmitted by the UE in the uplink, or via CSI reports from the UE.

Then, the gNB may determine whether or not to apply the effective channel null space projection approach based on the channel flatness (e.g., apply for flat channels and not for frequency-selective channels) and/or based on values of K and Z (e.g., apply only when L<K).

When the effective channel null space projection approach is to be applied, the gNB extracts two (K) precoders (precoder basis components) based on the propagation channel Hₙ∈ [symbol] in each n=1, . . . , N sub-carrier. For the sake of brevity, the sub-carrier index n will be dropped in some instances herein (e.g., H≙H₁≈H₂≈ . . . ≈Hₙ for a flat channel).

The precoders can be designed based on singular value decomposition (SVD), PMI feedback, or similar. Assuming SVD, the precoder basis components may be determined by the gNB by extracting two (K) strong right singular vectors v₁, v₂ of the propagation channel according to:

$$H = {UΣV}^{H} = {[ {u}_{1} {u}_{2} ] [ \begin{matrix}{σ}_{1} & 0 \\ 0 & {σ}_{2}\end{matrix} ] [ {v}_{1} {v}_{2} ]}^{H} ∈ {ℂ}^{2 \times M} ,$$

where U=[u₁ u₂] is the left-hand matrix of the SVD of H, V^{H}=[v₁ v₂]^{H} is the right-hand matrix of the SVD of H, and

$$Σ = [ \begin{matrix}{σ}_{1} & 0 \\ 0 & {σ}_{2}\end{matrix} ]$$

represents the singular values of H.

The gNB (linearly) combines the precoder basis components and introduces a new precoder p to precode the layer of data:

$$p = {α}_{1} {v}_{1} + {α}_{2} {v}_{2} = V [ \begin{matrix}{α}_{1} \\ {α}_{2}\end{matrix} ] ∈ {ℂ}^{M \times 1} ,$$

where α₁ and α₂ are coefficients of the linear combination.

Since massive CFR techniques work well with frequency-selective channels the precoder p is varied in frequency domain (e.g., every few sub-carriers or PRBs):

$${p}_{n} = {α}_{1 , n} {v}_{1} + {α}_{2 , n} {v}_{2} = V [ \begin{matrix}{α}_{1 , n} \\ {α}_{2 , n}\end{matrix} ] ∈ {ℂ}^{M \times 1} ,$$

For example, the gNB may change the combing coefficients α_{1,n} and α_{2,n}, and consequently the precoder pₙ, every 2 (or 4, 6, 8, etc.) PRBs to tap into the 3GPP standard where the UE is required to track the channel in frequency domain with a resolution of 2 PRBs. Then, the UE automatically keeps track of the precoder changes using the downlink demodulation reference signals (DMRS) and there is no need for overhead signaling (e.g., control or negotiation signaling) between the gNB and the UE to ensure proper function for the suggested approach. Thus, the projection onto effective channel null space can be implemented to be transparent to the UE, and to the 3GPP standard.

Alternatively or additionally, the gNB and the UE may negotiate the combining coefficients α_{1,n} and α_{2,n}, and/or the gNB may inform the UE of the selected combining coefficients α_{1,n} and α_{2,n}.

Yet, alternatively or additionally, the gNB selects the combining coefficients α_{1,n} and α_{2,n} based on a predefined sequence. For example, the combining coefficients α_{1,n} and α_{2,n} may be generated using a pseudo-random sequence (e.g., a Gold sequence). In this case, the pseudo-random sequence may be known to the UE and a seed value for the pseudo-random sequence may be negotiated, or provided by the gNB.

In the situation with a flat-fading propagation channel, the clipped-noise typically still heavily remains in the direction of the UE, but since L<K (i.e., extra receiver ports are available for handling the clipping noise) the UE can separate the desired signal from the clipping signal.

To demonstrate benefits of some embodiments, a (single-carrier) mathematical derivation of signal-to-noise-and distortion ratio (SNDR) will now be presented for some different receiver examples; interference rejection combiner (IRC), maximum ratio combining (MRC), and zero-forcing (ZF). IRC is a kind of unbiased minimum mean square error (MMSE) receiver, while ZF and MRC are special cases of the MMSE receiver.

It may be noted that no throughput is lost by the linear combining when the singular values are equally strong (frequency-flat channels typically have almost equal singular values; since the antennas at the UE and the gNB are dual polarized). Thus, the values of the coefficients α_{1,n} and α_{2,n} may be selected freely according to some embodiments.

When the singular values are not equally strong, compensation may be provided so that the average value (over frequency) of a coefficient relates to the average value of another coefficient in correspondence with how their respective singular values relate to each other (i.e., a relatively strong singular value should correspond to a relatively high average coefficient value).

### SNDR for IRC Receivers

Let

$$H = {UΣV}^{H} = {[ {u}_{1} {u}_{2} ] [ \begin{matrix}{σ}_{1} & 0 \\ 0 & {σ}_{2}\end{matrix} ] [ {v}_{1} {v}_{2} ]}^{H} ∈ {ℂ}^{2 \times M}$$

describe the reduced SVD of the propagation channel matrix between the UE with 2 antenna ports and the gNB with M antenna ports, and that the gNB uses precoder p∈ [symbol] to transmit one layer of data s. The sub-carrier indices are omitted, and the evaluation is presented for one single sub-carrier without loss of generality. According to some example approaches, two singular vectors v₁ and v₂ of the channel matrix H are combined to form the precoder p:

$$p = {α}_{1} {v}_{1} + {α}_{2} {v}_{2} = V [ \begin{matrix}{α}_{1} \\ {α}_{2}\end{matrix} ] ∈ {ℂ}^{M \times 1} ,$$

where α₁ and α₂ satisfy the below constraint to preserve the total power of the precoder:

$$1 = {‖ p ‖}_{2}^{2} = {‖ V [ \begin{matrix}{α}_{1} \\ {α}_{2}\end{matrix} ] ‖}_{2}^{2} = [ \begin{matrix}{α}_{1}^{*} & {α}_{2}^{*}\end{matrix} ] {V}^{H} V [ \begin{matrix}{α}_{1} \\ {α}_{2}\end{matrix} ] = {\vert {α}_{1} \vert}^{2} + {\vert {α}_{2} \vert}^{2} ,$$

where (⋅)* denotes the complex conjugate. Without loss of generality, the gNB is assumed to transmit only one layer of data (the scenario can be readily extended to higher number of data layers). Thus, the effective end-to-end channel is a vector hₑ∈ [symbol] . The gNB precodes the data symbols in the direction of the effective channel:

$${h}_{e} = {α}_{e} {p}^{H} = {α}_{e} [ \begin{matrix}{α}_{1}^{*} & {α}_{2}^{*}\end{matrix} ] {V}^{H} ∈ {ℂ}^{1 \times M} ,$$

where αₑ denotes the gain of the effective channel. The null space of this effective channel may be obtained by a projection matrix:

$$I - {h}_{e}^{+} {h}_{e} = I - {( {α}_{e} [ \begin{matrix}{α}_{1}^{*} & {α}_{2}^{*}\end{matrix} ] {V}^{H} )}^{+} {α}_{e} [ \begin{matrix}{α}_{1}^{*} & {α}_{2}^{*}\end{matrix} ] {V}^{H} = I - ( \frac{1}{{α}_{e}} V [ \begin{matrix}{α}_{1} \\ {α}_{2}\end{matrix} ] ) ( {α}_{e} [ \begin{matrix}{α}_{1}^{*} & {α}_{2}^{*}\end{matrix} ] {V}^{H} ) = I - V [ \begin{matrix}{α}_{1} \\ {α}_{2}\end{matrix} ] [ \begin{matrix}{α}_{1}^{*} & {α}_{2}^{*}\end{matrix} ] {V}^{H} ,$$

where

$${h}_{e}^{+}$$

denotes the Moore-Penrose Inverse (pseudo-inverse) of the vector (or more generally; matrix) hₑ. Using the massive CFR algorithm, the precoded vector for the sub-carrier under consideration is given by:

$$x = ps + ( I - {h}_{e}^{+} {h}_{e} ) z = ps + ( I - V [ \begin{matrix}{α}_{1} \\ {α}_{2}\end{matrix} ] [ \begin{matrix}{α}_{1}^{*} & {α}_{2}^{*}\end{matrix} ] {V}^{H} ) z ,$$

where the vector z denotes the accumulated clipped-noise achieved through conventional massive CFR (e.g., CRAM). The received vector at the UE ports is:

$$r = Hx + n = Hps + H ( I - {h}_{e}^{+} {h}_{e} ) z + n = U Σ {V}^{H} ( V [ \begin{matrix}{α}_{1} \\ {α}_{2}\end{matrix} ] ) s + U Σ {V}^{H} ( I - V [ \begin{matrix}{α}_{1} \\ {α}_{2}\end{matrix} ] [ \begin{matrix}{α}_{1}^{*} & {α}_{2}^{*}\end{matrix} ] {V}^{H} ) z + n = U Σ [ \begin{matrix}{α}_{1} \\ {α}_{2}\end{matrix} ] s + U Σ ( I - [ \begin{matrix}{α}_{1} \\ {α}_{2}\end{matrix} ] [ \begin{matrix}{α}_{1}^{*} & {α}_{2}^{*}\end{matrix} ] ) {V}^{H} z + n ,$$

where n represents background noise. A correlation matrix (K; not to be confused with the number K or receiver ports) of unwanted signals is calculated for the IRC receiver, where the unwanted signal comprises clipped-noise and background noise. The clipped-noise is independent of the background noise, i.e.,

$$K = E \{ ( unwanted signals ) {( unwanted signals )}^{H} \} = U Σ ( I - [ \begin{matrix}{α}_{1} \\ {α}_{2}\end{matrix} ] [ \begin{matrix}{α}_{1}^{*} & {α}_{2}^{*}\end{matrix} ] ) {V}^{H} {zz}^{H} V ( I - [ \begin{matrix}{α}_{1} \\ {α}_{2}\end{matrix} ] [ \begin{matrix}{α}_{1}^{*} & {α}_{2}^{*}\end{matrix} ] ) {Σ}^{H} {U}^{H} + E \{ {nn}^{H} \} = U Σ {QV}^{H} {zz}^{H} VQ {Σ}^{H} {U}^{H} + {σ}_{n}^{2} I ,$$

where E{⋅} denotes the expected value, and the background noise is assumed to be additive white Gaussian noise (AWGN) with a distribution

$$n \sim 𝒞𝒩 ( 0 , {σ}_{n}^{2} I )$$

(although it may be noted that the proposed approach does not critically rely on n being spatially white). The matrix Q is defined as:

$$Q {=}^{Δ} I - [ \begin{matrix}{α}_{1} \\ {α}_{2}\end{matrix} ] [ \begin{matrix}{α}_{1}^{*} & {α}_{2}^{*}\end{matrix} ] = I - [ \begin{matrix}{\vert {α}_{1} \vert}^{2} & {α}_{1} {α}_{2}^{*} \\ {α}_{2} {α}_{1}^{*} & {\vert {α}_{2} \vert}^{2}\end{matrix} ] = [ \begin{matrix}1 - {\vert {α}_{1} \vert}^{2} & - {α}_{1} {α}_{2}^{*} \\ - {α}_{2} {α}_{1}^{*} & 1 - {\vert {α}_{2} \vert}^{2}\end{matrix} ] = [ \begin{matrix}{\vert {α}_{2} \vert}^{2} & - {α}_{1} {α}_{2}^{*} \\ - {α}_{2} {α}_{1}^{*} & {\vert {α}_{1} \vert}^{2}\end{matrix} ] = [ \begin{matrix}{α}_{2}^{*} \\ - {α}_{1}^{*}\end{matrix} ] [ \begin{matrix}{α}_{2} & - {α}_{1}\end{matrix} ] .$$

Applying the IRC receiver to the received signal is a two-fold procedure w=w₂W₁, where

$${W}_{1} = {K}^{- \frac{1}{2}} and {w}_{2} = {( {K}^{- \frac{1}{2}} U Σ [ \begin{matrix}{α}_{1} \\ {α}_{2}\end{matrix} ] )}^{H} .$$

In a first step, W₁ is applied to whiten (de-correlate) the unwanted signals:

$${W}_{1} r = {K}^{- \frac{1}{2}} U Σ [ \begin{matrix}{α}_{1} \\ {α}_{2}\end{matrix} ] s + {K}^{- \frac{1}{2}} ( U Σ ( I - [ \begin{matrix}{α}_{1} \\ {α}_{2}\end{matrix} ] [ \begin{matrix}{α}_{1}^{*} & {α}_{2}^{*}\end{matrix} ] ) {V}^{H} z + n ) = {K}^{- \frac{1}{2}} U Σ [ \begin{matrix}{α}_{1} \\ {α}_{2}\end{matrix} ] s + \tilde{n} ,$$

where the de-correlated signal ñ is AWGN [symbol] (0, I), i.e., complex normal distributed AWGN. In a second step, the matched filter

$${w}_{2} = {( {K}^{- \frac{1}{2}} U Σ [ \begin{matrix}{α}_{1} \\ {α}_{2}\end{matrix} ] )}^{H}$$

is applied to complete the IRC procedure:

$$\hat{s} = {w}_{2} {W}_{1} r = {w}_{2} {K}^{- \frac{1}{2}} U Σ [ \begin{matrix}{α}_{1} \\ {α}_{2}\end{matrix} ] s + {w}_{2} \tilde{n} = {( {K}^{- \frac{1}{2}} U Σ [ \begin{matrix}{α}_{1} \\ {α}_{2}\end{matrix} ] )}^{H} {K}^{- \frac{1}{2}} U Σ [ \begin{matrix}{α}_{1} \\ {α}_{2}\end{matrix} ] s + {( {K}^{- \frac{1}{2}} U Σ [ \begin{matrix}{α}_{1} \\ {α}_{2}\end{matrix} ] )}^{H} \tilde{n} = [ \begin{matrix}{α}_{1}^{*} & {α}_{2}^{*}\end{matrix} ] {Σ}^{H} {U}^{H} {K}^{- 1} U Σ [ \begin{matrix}{α}_{1} \\ {α}_{2}\end{matrix} ] s + [ \begin{matrix}{α}_{1}^{*} & {α}_{2}^{*}\end{matrix} ] {Σ}^{H} {U}^{H} {K}^{- \frac{1}{2}} \tilde{n} .$$

It is noteworthy that normalization, or scaling, of the power of for the IRC combiner w=w₂W₁ is not required, since it is applied to both desired and unwanted signals. Thus, the signal-to-noise-and-distortion ratio (SNDR) becomes:

$$\begin{matrix}{SNDR}_{IRC} = \frac{\vert [ \begin{matrix}{α}_{1}^{*} & {α}_{2}^{*}\end{matrix} ] {Σ}^{H} {U}^{H} {K}^{- 1} U Σ [ \begin{matrix}{α}_{1} \\ {α}_{2}\end{matrix} ] \vert}{{‖ [ \begin{matrix}{α}_{1}^{*} & {α}_{2}^{*}\end{matrix} ] {Σ}^{H} {U}^{H} {K}^{- \frac{1}{2}} ‖}_{2}^{2}} \frac{{σ}_{s}^{2}}{{σ}_{\tilde{n}}^{2}} = \frac{{\vert [ \begin{matrix}{α}_{1}^{*} & {α}_{2}^{*}\end{matrix} ] {Σ}^{H} {U}^{H} {K}^{- 1} U Σ [ \begin{matrix}{α}_{1} \\ {α}_{2}\end{matrix} ] \vert}^{2}}{[ \begin{matrix}{α}_{1}^{*} & {α}_{2}^{*}\end{matrix} ] {Σ}^{H} {U}^{H} {K}^{- 1} U Σ [ \begin{matrix}{α}_{1} \\ {α}_{2}\end{matrix} ]} \frac{{σ}_{s}^{2}}{1} \\ = {σ}_{s}^{2} [ \begin{matrix}{α}_{1}^{*} & {α}_{2}^{*}\end{matrix} ] {Σ}^{H} {U}^{H} {K}^{- 1} U Σ [ \begin{matrix}{α}_{1} \\ {α}_{2}\end{matrix} ] \\ = {σ}_{s}^{2} [ \begin{matrix}{α}_{1}^{*} & {α}_{2}^{*}\end{matrix} ] {Σ}^{H} {{U}^{H} ( U Σ {QV}^{H} {zz}^{H} VQ {Σ}^{H} {U}^{H} + {σ}_{n}^{2} I )}^{- 1} U Σ [ \begin{matrix}{α}_{1} \\ {α}_{2}\end{matrix} ] \\ = {σ}_{s}^{2} [ \begin{matrix}{α}_{1}^{*} & {α}_{2}^{*}\end{matrix} ] {Σ}^{H} {U}^{H} {U ( Σ {QV}^{H} {zz}^{H} VQ {Σ}^{H} {U}^{H} + {σ}_{n}^{2} I )}^{- 1} {U}^{H} U Σ [ \begin{matrix}{α}_{1} \\ {α}_{2}\end{matrix} ] \\ = {σ}_{s}^{2} [ \begin{matrix}{α}_{1}^{*} & {α}_{2}^{*}\end{matrix} ] {{Σ}^{H} ( Σ {QV}^{H} {zz}^{H} VQ {Σ}^{H} {U}^{H} + {σ}_{n}^{2} I )}^{- 1} Σ [ \begin{matrix}{α}_{1} \\ {α}_{2}\end{matrix} ] \\ = {σ}_{s}^{2} [ \begin{matrix}{α}_{1}^{*} & {α}_{2}^{*}\end{matrix} ] {{Σ}^{H} ( Σ {QV}^{H} {zz}^{H} VQ {Σ}^{H} + {σ}_{n}^{2} {ΣΣ}^{- 1} {Σ}^{- H} {Σ}^{H} )}^{- 1} Σ [ \begin{matrix}{α}_{1} \\ {α}_{2}\end{matrix} ] \\ = {σ}_{s}^{2} [ \begin{matrix}{α}_{1}^{*} & {α}_{2}^{*}\end{matrix} ] {Σ}^{H} {{Σ}^{- H} ( {QV}^{H} {zz}^{H} VQ + {σ}_{n}^{2} {Σ}^{- 1} {Σ}^{- H} )}^{- 1} {Σ}^{- 1} Σ [ \begin{matrix}{α}_{1} \\ {α}_{2}\end{matrix} ] \\ = {σ}_{s}^{2} [ \begin{matrix}{α}_{1}^{*} & {α}_{2}^{*}\end{matrix} ] {( {QV}^{H} {zz}^{H} VQ + {σ}_{n}^{2} {Σ}^{- 2} )}^{- 1} [ \begin{matrix}{α}_{1} \\ {α}_{2}\end{matrix} ] .\end{matrix}$$

Presenting the clipped noise z according to the basis of the channel matrix, i.e., z=β₁v₁+β₂v₂+ . . . +β_{M}v_{M}, it can be seen that the projected clipped-noise resides in the direction of v₃, . . . , v_{M}, and becomes zero after being multiplied by V^{H}. Hence,

$$\begin{matrix}{SNDR}_{IRC} = {σ}_{s}^{2} [ \begin{matrix}{α}_{1}^{*} & {α}_{2}^{*}\end{matrix} ] {( {QV}^{H} {zz}^{H} VQ + {σ}_{n}^{2} {Σ}^{- 2} )}^{- 1} [ \begin{matrix}{α}_{1} \\ {α}_{2}\end{matrix} ] \\ = {σ}_{s}^{2} [ \begin{matrix}{α}_{1}^{*} & {α}_{2}^{*}\end{matrix} ] {( {QV}^{H} ( {β}_{1} {v}_{1} + {β}_{2} {v}_{2} + ⋯ + {β}_{m} {v}_{m} ) {( {β}_{1} {v}_{1} + {β}_{2} {v}_{2} + ⋯ + {β}_{m} {v}_{m} )}^{H} VQ + {σ}_{n}^{2} {Σ}^{- 2} )}^{- 1} [ \begin{matrix}{α}_{1} \\ {α}_{2}\end{matrix} ] \\ = {σ}_{s}^{2} [ \begin{matrix}{α}_{1}^{*} & {α}_{2}^{*}\end{matrix} ] {( {QV}^{H} ( {β}_{1} {v}_{1} + {β}_{2} {v}_{2} ) {( {β}_{1} {v}_{1} + {β}_{2} {v}_{2} )}^{H} VQ + {σ}_{n}^{2} {Σ}^{- 2} )}^{- 1} [ \begin{matrix}{α}_{1} \\ {α}_{2}\end{matrix} ] \\ = {σ}_{s}^{2} [ \begin{matrix}{α}_{1}^{*} & {α}_{2}^{*}\end{matrix} ] {( Q ⌈ \begin{matrix}{β}_{1} \\ {β}_{2}\end{matrix} ⌉ [ \begin{matrix}{β}_{1}^{*} & {β}_{2}^{*}\end{matrix} ] Q + {σ}_{n}^{2} {Σ}^{- 2} )}^{- 1} [ \begin{matrix}{α}_{1} \\ {α}_{2}\end{matrix} ] \\ = {σ}_{s}^{2} [ \begin{matrix}{α}_{1}^{*} & {α}_{2}^{*}\end{matrix} ] {( [ \begin{matrix}{α}_{2}^{*} \\ - {α}_{1}^{*}\end{matrix} ] [ \begin{matrix}{α}_{2} & - {α}_{1}\end{matrix} ] ⌈ \begin{matrix}{β}_{1} \\ {β}_{2}\end{matrix} ⌉ [ \begin{matrix}{β}_{1}^{*} & {β}_{2}^{*}\end{matrix} ] ⌈ \begin{matrix}{α}_{2}^{*} \\ - {α}_{1}^{*}\end{matrix} ⌉ [ \begin{matrix}{α}_{2} & - {α}_{1}\end{matrix} ] + {σ}_{n}^{2} {Σ}^{- 2} )}^{- 1} [ \begin{matrix}{α}_{1} \\ {α}_{2}\end{matrix} ] \\ = {σ}_{s}^{2} [ \begin{matrix}{α}_{1}^{*} & {α}_{2}^{*}\end{matrix} ] {( [ \begin{matrix}{α}_{2}^{*} \\ - {α}_{1}^{*}\end{matrix} ] ( {α}_{2} {β}_{1} - {α}_{1} {β}_{2} ) ( {β}_{1}^{*} {α}_{2}^{*} - {β}_{2}^{*} {α}_{1}^{*} ) [ \begin{matrix}{α}_{2} & - {α}_{1}\end{matrix} ] + {σ}_{n}^{2} {Σ}^{- 2} )}^{- 1} [ \begin{matrix}{α}_{1} \\ {α}_{2}\end{matrix} ] \\ = {σ}_{s}^{2} [ \begin{matrix}{α}_{1}^{*} & {α}_{2}^{*}\end{matrix} ] {( [ \begin{matrix}{α}_{2}^{*} \\ - {α}_{1}^{*}\end{matrix} ] ( {\vert {β}_{1}^{*} {α}_{2}^{*} - {β}_{2}^{*} {α}_{1}^{*} \vert}^{2} ) [ \begin{matrix}{α}_{2} & - {α}_{1}\end{matrix} ] + {σ}_{n}^{2} {Σ}^{- 2} )}^{- 1} [ \begin{matrix}{α}_{1} \\ {α}_{2}\end{matrix} ] \\ = {σ}_{s}^{2} [ \begin{matrix}{α}_{1}^{*} & {α}_{2}^{*}\end{matrix} ] {\underbrace{{( {σ}_{n}^{2} {Σ}^{- 2} + [ \begin{matrix}{α}_{2}^{*} \\ - {α}_{1}^{*}\end{matrix} ] ( {\vert {β}_{1}^{*} {α}_{2}^{*} - {β}_{2}^{*} {α}_{1}^{*} \vert}^{2} ) [ \begin{matrix}{α}_{2} & - {α}_{1}\end{matrix} ] )}^{- 1}}}_{T} [ \begin{matrix}{α}_{1} \\ {α}_{2}\end{matrix} ] .\end{matrix}$$

Simplification of T may be achieved by using the Sherman-Morrison-Woodbury formula for the invertible matrices A and C:

$${( A + B C D )}^{- 1} = {A}^{- 1} - {A}^{- 1} {B ( {C}^{- 1} + D {A}^{- 1} B )}^{- 1} D {A}^{- 1} ,$$

$$with A {=}^{Δ} {σ}_{n}^{2} {Σ}^{- 2} , B {=}^{Δ} ⌈ \begin{matrix}{α}_{2}^{*} \\ - {α}_{1}^{*}\end{matrix} ⌉ , C {=}^{Δ} {\vert {β}_{1}^{*} {α}_{2}^{*} - {β}_{2}^{*} {α}_{1}^{*} \vert}^{2} , and D {=}^{Δ} [ \begin{matrix}{α}_{2} & - {α}_{1}\end{matrix} ] , i . e . ,$$

$$T = {( {σ}_{n}^{2} {Σ}^{- 2} + [ \begin{matrix}{α}_{2}^{*} \\ - {α}_{1}^{*}\end{matrix} ] ( {\vert {β}_{1}^{*} {α}_{2}^{*} - {β}_{2}^{*} {α}_{1}^{*} \vert}^{2} ) [ \begin{matrix}{α}_{2} & - {α}_{1}\end{matrix} ] )}^{- 1} = \frac{{Σ}^{2}}{{σ}_{n}^{2}} - \frac{{Σ}^{2}}{{σ}_{n}^{2}} [ \begin{matrix}{α}_{2}^{*} \\ - {α}_{1}^{*}\end{matrix} ] ( \frac{1}{{\vert {β}_{1}^{*} {α}_{2}^{*} - {β}_{2}^{*} {α}_{1}^{*} \vert}^{2}} + \begin{matrix}[ {α}_{2} & {- {α}_{1} ] \frac{{Σ}^{2}}{{σ}_{n}^{2}} [ \begin{matrix}{α}_{2}^{*} \\ - {α}_{1}^{*}\end{matrix} ] )}^{- 1} [ \begin{matrix}{α}_{2} & - {α}_{1}\end{matrix} ] \frac{{Σ}^{2}}{{σ}_{n}^{2}}\end{matrix} = \frac{{Σ}^{2}}{{σ}_{n}^{2}} - \frac{1}{{σ}_{n}^{2}} [ \begin{matrix}{α}_{2}^{*} {σ}_{1}^{2} \\ - {α}_{1}^{*} {σ}_{2}^{2}\end{matrix} ] {( \frac{1}{{\vert {β}_{1}^{*} {α}_{2}^{*} - {β}_{2}^{*} {α}_{1}^{*} \vert}^{2}} + \frac{{σ}_{1}^{2} {\vert {α}_{2} \vert}^{2} + {σ}_{2}^{2} {\vert {α}_{1} \vert}^{2}}{{σ}_{n}^{2}} )}^{- 1} \frac{[ \begin{matrix}{α}_{2} {σ}_{1}^{2} & - {α}_{1} {σ}_{2}^{2} ]\end{matrix}}{{σ}_{n}^{2}} = \frac{{Σ}^{2}}{{σ}_{n}^{2}} - \frac{1}{{σ}_{n}^{4}} {( \frac{1}{{\vert {β}_{1}^{*} {α}_{2}^{*} - {β}_{2}^{*} {α}_{1}^{*} \vert}^{2}} + \frac{{σ}_{1}^{2} {\vert {α}_{2} \vert}^{2} + {σ}_{2}^{2} {\vert {α}_{1} \vert}^{2}}{{σ}_{n}^{2}} )}^{- 1} [ \begin{matrix}{α}_{2}^{*} {σ}_{1}^{2} \\ - {α}_{1}^{*} {σ}_{2}^{2}\end{matrix} ] [ \begin{matrix}{α}_{2} {σ}_{1}^{2} & - {α}_{1} {σ}_{2}^{2} ] ,\end{matrix}$$

and substituting into the expression for SNDR:

$${SNDR}_{IRC} = {σ}_{s}^{2} [ \begin{matrix}{α}_{1}^{*} & {α}_{2}^{*}\end{matrix} ] {\underbrace{{( {σ}_{n}^{2} {Σ}^{- 2} + [ \begin{matrix}{α}_{2}^{*} \\ - {α}_{1}^{*}\end{matrix} ] ( {\vert {β}_{1}^{*} {α}_{2}^{*} - {β}_{2}^{*} {α}_{1}^{*} \vert}^{2} ) [ \begin{matrix}{α}_{2} & - {α}_{1}\end{matrix} ] )}^{- 1}}}_{T} [ \begin{matrix}{α}_{1} \\ {α}_{2}\end{matrix} ] = {σ}_{s}^{2} \begin{matrix}[ {α}_{1}^{*} & {α}_{2}^{*} ] ( \frac{{Σ}^{2}}{{σ}_{n}^{2}}\end{matrix} - \frac{1}{{σ}_{n}^{4}} {( \frac{1}{{\vert {β}_{1}^{*} {α}_{2}^{*} - {β}_{2}^{*} {α}_{1}^{*} \vert}^{2}} + \frac{{σ}_{1}^{2} {\vert {α}_{2} \vert}^{2} + {σ}_{2}^{2} {\vert {α}_{1} \vert}^{2}}{{σ}_{n}^{2}} )}^{- 1} [ \begin{matrix}{α}_{2}^{*} {σ}_{1}^{2} \\ - {α}_{1}^{*} {σ}_{2}^{2}\end{matrix} ] [ \begin{matrix}{α}_{2} {σ}_{1}^{2} & - {α}_{1} {σ}_{2}^{2} ] ) [ \begin{matrix}{α}_{1} \\ {α}_{2}\end{matrix} ]\end{matrix} = {σ}_{s}^{2} [ \begin{matrix}{α}_{1}^{*} & {α}_{2}^{*}\end{matrix} ] \frac{{Σ}^{2}}{{σ}_{n}^{2}} [ \begin{matrix}{α}_{1} \\ {α}_{2}\end{matrix} ] - ( \frac{{σ}_{s}^{2}}{{σ}_{n}^{4}} ) {( \frac{1}{{\vert {β}_{1}^{*} {α}_{2}^{*} - {β}_{2}^{*} {α}_{1}^{*} \vert}^{2}} + \frac{{σ}_{1}^{2} {\vert {α}_{2} \vert}^{2} + {σ}_{2}^{2} {\vert {α}_{1} \vert}^{2}}{{σ}_{n}^{2}} )}^{- 1} \begin{matrix}[ {α}_{1}^{*} & {α}_{2}^{*} ] [ \begin{matrix}{α}_{2}^{*} {σ}_{1}^{2} \\ - {α}_{1}^{*} {σ}_{2}^{2}\end{matrix} ] [ \begin{matrix}{α}_{2} {σ}_{1}^{2} & - {α}_{1} {σ}_{2}^{2}\end{matrix} ] [ \begin{matrix}{α}_{1} \\ {α}_{2}\end{matrix} ]\end{matrix} = ( \frac{{σ}_{s}^{2} ( {σ}_{1}^{2} {\vert {α}_{1} \vert}^{2} + {σ}_{2}^{2} {\vert {α}_{2} \vert}^{2} )}{{σ}_{n}^{2}} ) - ( \frac{{σ}_{s}^{2}}{{σ}_{n}^{4}} ) {( \frac{1}{{\vert {β}_{1}^{*} {α}_{2}^{*} - {β}_{2}^{*} {α}_{1}^{*} \vert}^{2}} + \frac{{σ}_{1}^{2} {\vert {α}_{2} \vert}^{2} + {σ}_{2}^{2} {\vert {α}_{1} \vert}^{2}}{{σ}_{n}^{2}} )}^{- 1} ( {α}_{1}^{*} {α}_{2}^{*} {σ}_{1}^{2} - {α}_{1}^{*} {α}_{2}^{*} {σ}_{2}^{2} ) ( {α}_{1} {α}_{2} {σ}_{1}^{2} - {α}_{1} {α}_{2} {σ}_{2}^{2} ) = ( \frac{{σ}_{s}^{2} ( {σ}_{1}^{2} {\vert {α}_{1} \vert}^{2} + {σ}_{2}^{2} {\vert {α}_{2} \vert}^{2} )}{{σ}_{n}^{2}} ) - ( \frac{{σ}_{s}^{2}}{{σ}_{n}^{4}} ) {( \frac{1}{{\vert {β}_{1}^{*} {α}_{2}^{*} - {β}_{2}^{*} {α}_{1}^{*} \vert}^{2}} + \frac{{σ}_{1}^{2} {\vert {α}_{2} \vert}^{2} + {σ}_{2}^{2} {\vert {α}_{1} \vert}^{2}}{{σ}_{n}^{2}} )}^{- 1} ( {α}_{1}^{*} {α}_{2}^{*} ( {σ}_{1}^{2} - {σ}_{2}^{2} ) {α}_{1} {α}_{2} ( {σ}_{1}^{2} - {σ}_{2}^{2} ) ) = ( \frac{{σ}_{s}^{2}}{{σ}_{n}^{2}} ) ( {σ}_{1}^{2} {\vert {α}_{1} \vert}^{2} + {σ}_{2}^{2} {\vert {α}_{2} \vert}^{2} ) - ( \frac{{σ}_{s}^{2}}{{σ}_{n}^{4}} ) {( \frac{1}{{\vert {β}_{1}^{*} {α}_{2}^{*} - {β}_{2}^{*} {α}_{1}^{*} \vert}^{2}} + \frac{{σ}_{1}^{2} {\vert {α}_{2} \vert}^{2} + {σ}_{2}^{2} {\vert {α}_{1} \vert}^{2}}{{σ}_{n}^{2}} )}^{- 1} {\vert {α}_{1} {α}_{2} \vert}^{2} {\vert {σ}_{1}^{2} - {σ}_{2}^{2} \vert}^{2}$$

For strong LOS channels, the singular values are (almost) the same over two polarizations, so σ₁≈σ₂≈σ. Therefore, SNDR_{IRC} can be simplified to:

$$\begin{matrix}{SNDR}_{IRC , LOS} = ( \frac{{σ}_{s}^{2}}{{σ}_{n}^{2}} ) ( {σ}^{2} {\vert {α}_{1} \vert}^{2} + {σ}^{2} {\vert {α}_{2} \vert}^{2} ) - 0 \\ = ( \frac{{σ}_{s}^{2}}{{σ}_{n}^{2}} ) {σ}^{2} ( {\vert {α}_{1} \vert}^{2} + {\vert {α}_{2} \vert}^{2} ) \\ = \frac{{σ}_{s}^{2} {σ}^{2}}{{σ}_{n}^{2}} \\ = {σ}^{2} SNR ,\end{matrix}$$

which indicates that the SNDR is independent of the combining coefficients (i.e., α₁ and α₂) for LOS channels.

### SNDR for MRC Receivers

Recalling the received signal at the UE:

$$r = U Σ [ \begin{matrix}{α}_{1} \\ {α}_{2}\end{matrix} ] s + U Σ ( I - [ \begin{matrix}{α}_{1} \\ {α}_{2}\end{matrix} ] [ \begin{matrix}{α}_{1}^{*} & {α}_{2}^{*}\end{matrix} ] ) {V}^{H} z + n ,$$

and applying the MRC receiver, where the received vector r is pre-multiplied by the vector

$${( U Σ [ \begin{matrix}{α}_{1} \\ {α}_{2}\end{matrix} ] )}^{H} ,$$

it can be seen that:

it can be

$${w}_{MRC} r = [ \begin{matrix}{α}_{1}^{*} & {α}_{2}^{*}\end{matrix} ] {Σ}^{H} {U}^{H} U Σ [ \begin{matrix}{α}_{1} \\ {α}_{2}\end{matrix} ] s + [ \begin{matrix}{α}_{1}^{*} & {α}_{2}^{*}\end{matrix} ] {Σ}^{H} {U}^{H} U Σ ( I - [ \begin{matrix}{α}_{1} \\ {α}_{2}\end{matrix} ] [ \begin{matrix}{α}_{1}^{*} & {α}_{2}^{*}\end{matrix} ] ) {V}^{H} z + [ \begin{matrix}{α}_{1}^{*} & {α}_{2}^{*}\end{matrix} ] {Σ}^{H} {U}^{H} n = [ \begin{matrix}{α}_{1}^{*} & {α}_{2}^{*}\end{matrix} ] {Σ}^{H} Σ [ \begin{matrix}{α}_{1} \\ {α}_{2}\end{matrix} ] s + [ \begin{matrix}{α}_{1}^{*} & {α}_{2}^{*}\end{matrix} ] {Σ}^{H} Σ ( [ \begin{matrix}{α}_{2}^{*} \\ - {α}_{1}^{*}\end{matrix} ] [ \begin{matrix}{α}_{2} & - {α}_{1}\end{matrix} ] ) {V}^{H} z + [ \begin{matrix}{α}_{1}^{*} & {α}_{2}^{*}\end{matrix} ] {Σ}^{H} {U}^{H} n = ( {σ}_{1}^{2} {\vert {α}_{1} \vert}^{2} + {σ}_{2}^{2} {\vert {α}_{2} \vert}^{2} ) s + ( {σ}_{1}^{2} {α}_{1}^{*} {α}_{2}^{*} - {σ}_{2}^{2} {α}_{1}^{*} {α}_{2}^{*} ) [ \begin{matrix}{α}_{2} & - {α}_{1}\end{matrix} ] {V}^{H} z + [ \begin{matrix}{α}_{1}^{*} & {α}_{2}^{*}\end{matrix} ] {Σ}^{H} {U}^{H} n = ( {σ}_{1}^{2} {\vert {α}_{1} \vert}^{2} + {σ}_{2}^{2} {\vert {α}_{2} \vert}^{2} ) s + ( {σ}_{1}^{2} - {σ}_{2}^{2} ) {α}_{1}^{*} {α}_{2}^{*} [ \begin{matrix}{α}_{2} & - {α}_{1}\end{matrix} ] {V}^{H} ( {β}_{1} {ν}_{1} + {β}_{2} {ν}_{2} + ⋯ + {β}_{m} {ν}_{m} ) + [ \begin{matrix}{α}_{1}^{*} & {α}_{2}^{*}\end{matrix} ] {Σ}^{H} {U}^{H} n = ( {σ}_{1}^{2} {\vert {α}_{1} \vert}^{2} + {σ}_{2}^{2} {\vert {α}_{2} \vert}^{2} ) s + ( {σ}_{1}^{2} - {σ}_{2}^{2} ) {α}_{1}^{*} {α}_{2}^{*} [ \begin{matrix}{α}_{2} & - {α}_{1}\end{matrix} ] [ \begin{matrix}{β}_{1} \\ {β}_{2}\end{matrix} ] + [ \begin{matrix}{α}_{1}^{*} {σ}_{1} & {α}_{2}^{*} {σ}_{2}\end{matrix} ] {U}^{H} n = ( {σ}_{1}^{2} {\vert {α}_{1} \vert}^{2} + {σ}_{2}^{2} {\vert {α}_{2} \vert}^{2} ) s + ( {σ}_{1}^{2} - {σ}_{2}^{2} ) {α}_{1}^{*} {α}_{2}^{*} ( {α}_{2} {β}_{1} - {α}_{1} {β}_{2} ) + [ \begin{matrix}{α}_{1}^{*} {σ}_{1} & {α}_{2}^{*} {σ}_{2}\end{matrix} ] \check{n} ,$$

where ň has a complex normal distribution

$$\check{n} \sim 𝒞𝒩 ( 0 , {σ}_{n}^{2} I )$$

since the unitary matrix does not change the probability density function (PDF) of n. The SNDR may be obtained as:

$${SNDR}_{MRC} = \frac{{( {σ}_{1}^{2} {\vert {α}_{1} \vert}^{2} + {σ}_{2}^{2} {\vert {α}_{2} \vert}^{2} )}^{2} {σ}_{s}^{2}}{{( {σ}_{1}^{2} - {σ}_{2}^{2} )}^{2} {\vert {α}_{1} {α}_{2} \vert}^{2} {\vert {α}_{2} {β}_{1} - {α}_{1} {β}_{2} \vert}^{2} + ( {σ}_{1}^{2} {\vert {α}_{1} \vert}^{2} + {σ}_{2}^{2} {\vert {α}_{2} \vert}^{2} ) {σ}_{n}^{2}} .$$

When σ₁≈σ₂≈σ, the SNDR_{MRC} may be simplified and shown to be related to the SNDR for IRC receivers:

$$\begin{matrix}{SNDR}_{MRC , LOS} = \frac{{( {σ}^{2} {\vert {α}_{1} \vert}^{2} + {σ}^{2} {\vert {α}_{2} \vert}^{2} )}^{2} {σ}_{s}^{2}}{0 + ( {σ}^{2} {\vert {α}_{1} \vert}^{2} + {σ}^{2} {\vert {α}_{2} \vert}^{2} ) {σ}_{n}^{2}} \\ = ( {σ}^{2} {\vert {α}_{1} \vert}^{2} + {σ}^{2} {\vert {α}_{2} \vert}^{2} ) \frac{{σ}_{s}^{2}}{{σ}_{n}^{2}} \\ = {σ}^{2} ( {\vert {α}_{1} \vert}^{2} + {\vert {α}_{2} \vert}^{2} ) \frac{{σ}_{s}^{2}}{{σ}_{n}^{2}} \\ = {σ}^{2} \frac{{σ}_{s}^{2}}{{σ}_{n}^{2}} \\ = {σ}^{2} SNR .\end{matrix}$$

### SNDR for ZF Receivers

Recalling the received signal at the UE:

$$r = U Σ [ \begin{matrix}{α}_{1} \\ {α}_{2}\end{matrix} ] s + U Σ ( I - [ \begin{matrix}{α}_{1} \\ {α}_{2}\end{matrix} ] [ \begin{matrix}{α}_{1}^{*} & {α}_{2}^{*}\end{matrix} ] ) {V}^{H} z + n ,$$

and applying the ZF (de-correlator) receiver, where the interference is nulled, i.e.,

$${w}_{ZF} = [ \begin{matrix}{α}_{1}^{*} & {α}_{2}^{*}\end{matrix} ] {Σ}^{- 1} {U}^{H} ,$$

it can be seen that:

$${w}_{ZF} r = [ \begin{matrix}{α}_{1}^{*} & {α}_{2}^{*}\end{matrix} ] {Σ}^{- 1} {U}^{H} U Σ [ \begin{matrix}{α}_{1} \\ {α}_{2}\end{matrix} ] s + [ \begin{matrix}{α}_{1}^{*} & {α}_{2}^{*}\end{matrix} ] {Σ}^{- 1} {U}^{H} U Σ ( I - [ \begin{matrix}{α}_{1} \\ {α}_{2}\end{matrix} ] [ \begin{matrix}{α}_{1}^{*} & {α}_{2}^{*}\end{matrix} ] ) {V}^{H} z + [ \begin{matrix}{α}_{1}^{*} & {α}_{2}^{*}\end{matrix} ] {Σ}^{- 1} {U}^{H} n = [ \begin{matrix}{α}_{1}^{*} & {α}_{2}^{*}\end{matrix} ] [ \begin{matrix}{α}_{1} \\ {α}_{2}\end{matrix} ] s + [ \begin{matrix}{α}_{1}^{*} & {α}_{2}^{*}\end{matrix} ] ( I - [ \begin{matrix}{α}_{1} \\ {α}_{2}\end{matrix} ] [ \begin{matrix}{α}_{1}^{*} & {α}_{2}^{*}\end{matrix} ] ) {V}^{H} z + [ \begin{matrix}{α}_{1}^{*} & {α}_{2}^{*}\end{matrix} ] {Σ}^{- 1} {U}^{H} n = ( {\vert {α}_{1} \vert}^{2} + {\vert {α}_{2} \vert}^{2} ) s + 0 + [ \begin{matrix}{α}_{1}^{*} & {α}_{2}^{*}\end{matrix} ] {Σ}^{- 1} {U}^{H} n = s + [ \begin{matrix}{α}_{1}^{*} & {α}_{2}^{*}\end{matrix} ] [ \begin{matrix}\frac{1}{{σ}_{1}} & 0 \\ 0 & \frac{1}{{σ}_{2}}\end{matrix} ] {U}^{H} n = s + [ \begin{matrix}\frac{{α}_{1}^{*}}{{σ}_{1}} & \frac{{α}_{2}^{*}}{{σ}_{2}}\end{matrix} ] {U}^{H} n = s + \hat{n} .$$

It may be noted that the unitary matrix U^{H} does not change the PDF of the random vector n. Therefore,

$$\hat{n} \sim 𝒞𝒩 ( 0 , ( \frac{{\vert {α}_{1} \vert}^{2}}{{σ}_{1}^{2}} + \frac{{\vert {α}_{2} \vert}^{2}}{{σ}_{2}^{2}} ) {σ}_{n}^{2} )$$

is an AWGN vector, and the SNDR is given by:

$${SNDR}_{ZF} = \frac{1}{( \frac{{\vert {α}_{1} \vert}^{2}}{{σ}_{1}^{2}} + \frac{{\vert {α}_{2} \vert}^{2}}{{σ}_{2}^{2}} )} \frac{{σ}_{s}^{2}}{{σ}_{n}^{2}} .$$

When σ₁≈σ₂≈σ, the SNDR_{ZF,LOS} may be simplified and shown to be related to the SNDR for IRC receivers:

$${SNDR}_{Z F , LOS} = \frac{1}{( \frac{{\vert {α}_{1} \vert}^{2}}{{σ}^{2}} + \frac{{\vert {α}_{2} \vert}^{2}}{{σ}^{2}} )} \frac{{σ}_{s}^{2}}{{σ}_{n}^{2}} = {σ}^{2} S N R .$$

Link level simulations have been performed showing that PAPR reduction and throughput may be improved by application of the proposed approaches; compared to approaches without CFR and approaches with conventional CFR (CRAM).

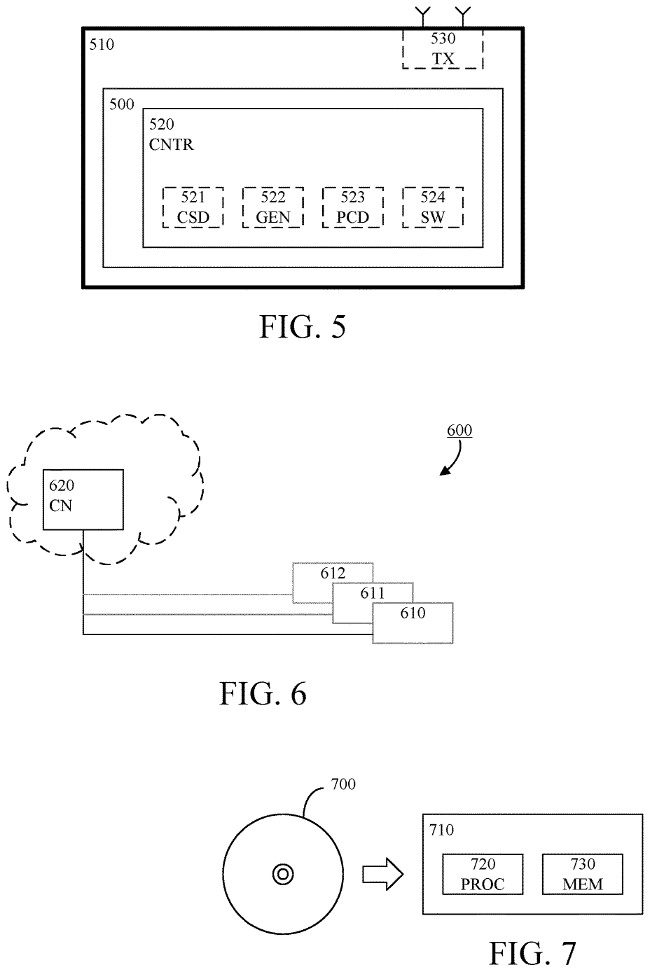

FIG. 5 schematically illustrates an example apparatus 500 according to some embodiments. The apparatus 500 is for reduction of peak-to-average power ratio (PAPR) of transmission using multiple-input multiple-output (MIMO) from a transmitter.

For example, the apparatus 500 may be configured to cause performance of (e.g., perform) one or more method steps as described above (e.g., in connection with FIG. 1).

In some embodiments, the apparatus 500 is comprised (or comprisable) in a communication device 510. For example, the communication device 510 may be a radio access node, a user device, or a control node. When the communication device 510 is a radio access node, or a user device, the communication device 510 may also comprise a transmitter (TX; e.g., transmission circuitry or a transmission module) 530. When the communication device 510 is a control node, the transmitter of the MIMO signal may be comprised in another communication device (e.g., a radio access node or user device; controlled by the control node).

When the communication device 510 is a radio access node the MIMO transmission may, for example, be downlink transmission (e.g., the receiver(s) may be user device(s)), or backhaul transmission (e.g., the receiver(s) may be other radio access node(s)).

When the communication device 510 is a user device the MIMO transmission may, for example, be uplink transmission (e.g., the receiver(s) may be radio access node(s)), or device-to-device transmission (e.g., the receiver(s) may be other user device(s)).

The apparatus 500 and/or the communication device 510 may, for example, comprise the precoder 302 of FIG. 3 and/or one or more parts of the arrangement described in connection with FIG. 4.

The apparatus 500 comprises a controller (CNTR; e.g., controlling circuitry, or a control module) 520.

The controller 520 is configured to cause determination of a clipping signal for the MIMO signal (compare with 142 of FIG. 1).

To this end, the controller 520 may comprise, or be otherwise associated with (e.g., connected, or connectable, to), a clipping signal determiner (CSD; e.g., determining circuitry, or a determination module) 521. The clipping signal determiner 521 may be configured to determine clipping signal.

The controller 520 is also configured to cause generation of a PAPR reduced MIMO signal for transmission by combination of the MIMO signal with a projection of the clipping signal onto a null space of an effective channel (compare with 144 of FIG. 1).

To this end, the controller 520 may comprise, or be otherwise associated with (e.g., connected, or connectable, to), a generator (GEN; e.g., generating circuitry, or a generation module) 522. The generator 522 may be configured to generate the PAPR reduced MIMO signal.

As already explained, the effective channel comprises a propagation channel between the transmitter and one or more receivers as affected by receiver combining matching the transmitter precoding, wherein a setting of the transmitter precoding varies over frequency.

The controller 520 may also be configured to cause transmission of the PAPR reduced MIMO signal (compare with 150 of FIG. 1).

To this end, the controller may comprise, or be otherwise associated with (e.g., connected, or connectable, to), the transmitter (TX; e.g., transmitting circuitry, or a transmission module) 530. The transmitter 530 may be configured to transmit the PAPR reduced MIMO signal over the propagation channel using the setting of the transmitter precoding.

The controller 520 may also be configured to cause determination of the setting of the transmitter precoding (compare with 130 of FIG. 1).

To this end, the controller 520 may comprise, or be otherwise associated with (e.g., connected, or connectable, to), a precoding determiner (PCD; e.g., determining circuitry, or a determination module) 523. The determiner 523 may be configured to determine the setting of the transmitter precoding.

In some embodiments, the controller 520 is configured to selectively apply the effective channel for null space projection only when the number of MIMO layers for the transmission is lower than the amount of receiver antenna ports (compare with 125 of FIG. 1) and/or only when the propagation channel fulfills a frequency flatness condition (compare with 120 of FIG. 1).

To this end, the controller may comprise, or be otherwise associated with (e.g., connected, or connectable, to), a switcher (SW; e.g., switching circuitry, or a switch module) 524. The switcher 524 may be configured to determine whether the number of MIMO layers for the transmission is lower than the amount of receiver antenna ports and/or whether the frequency flatness condition is fulfilled, and control the operation accordingly. For example, responsive to the frequency flatness condition being fulfilled, the switcher may set the controller 520 to operate in a first mode where an effective channel is applied for null space projection as explained herein. In some embodiments, the switcher 524 may set the controller 520 to operate in a second mode responsive to the frequency flatness condition being not fulfilled, wherein the effective channel is not applied for null space projection.

As already mentioned, the transmitter may be comprised in another communication device when the communication device 510 is a control node. Then, the controller 520 may be configured to cause some of the actions described above to be performed by the control node, and cause other ones of the actions described above to be performed by the other device (e.g., as exemplified in connection with FIG. 1).

It should be noted that any features described elsewhere in this description (e.g., in connection with FIG. 1) are equally applicable to the apparatus 500 of FIG. 5, even if not explicitly mentioned in connection thereto.

FIG. 6 schematically illustrates an example system 600 according to some embodiments. The system 600 comprises a plurality of radio access nodes 610, 611, 612, and a control node (CN; e.g., a central network node, a cloud server, or an edge computing node) 620.

The control node 620 is configured to control one or more of the radio access nodes 610, 611, 612 for PAPR reduction of MIMO transmission from a transmitter of the controlled radio access node. For example, the control node 620 may comprise the apparatus 500 as described in connection with FIG. 5.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a communication device (e.g., a radio access node, a user device, or a control node).

Embodiments may appear within an electronic apparatus (such as a communication device) comprising arrangements, circuitry, and/or logic according to any of the embodiments described herein. Alternatively or additionally, an electronic apparatus (such as a communication device) may be configured to perform methods according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 7 illustrates an example computer readable medium in the form of a compact disc (CD) ROM 700. The computer readable medium has stored thereon a computer program comprising program instructions. The computer program is loadable into a data processor (PROC; e.g., a data processing unit) 720, which may, for example, be comprised in a communication device 710. When loaded into the data processor, the computer program may be stored in a memory (MEM) 730 associated with, or comprised in, the data processor. According to some embodiments, the computer program may, when loaded into, and run by, the data processor, cause execution of method steps according to, for example, the method illustrated in FIG. 1, or as otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method for reduction of peak-to-average power ratio (PAPR) of transmission of a multiple-input multiple-output (MIMO) signal from a transmitter, wherein the transmission comprises a number of MIMO layers, the method comprising:
determining a clipping signal for the MIMO signal; and
generating a PAPR reduced MIMO signal for transmission by combining the MIMO signal with a projection of the clipping signal onto a null space of an effective channel, wherein
the effective channel comprises a propagation channel between the transmitter and one or more receivers as affected by receiver combining matching transmitter precoding,
the receivers have an amount of receiver antenna ports, and
a setting of the transmitter precoding is varied over frequency.

2-19. (canceled)

20. A non-transitory computer readable medium storing a computer program comprising program instructions, the computer program being loadable into a data processing unit and configured to cause execution of the method of claim 1 when the computer program is run by the data processing unit.

21. An apparatus for reduction of peak-to-average power ratio (PAPR) of transmission of a multiple-input multiple-output (MIMO) signal from a transmitter, wherein the transmission comprises a number of MIMO layers, the apparatus comprising controlling circuitry configured to cause the apparatus to perform a method comprising:
determining a clipping signal for the MIMO signal; and
generating a PAPR reduced MIMO signal for transmission by combination of the MIMO signal with a projection of the clipping signal onto a null space of an effective channel, wherein
the effective channel comprises a propagation channel between the transmitter and one or more receivers as affected by receiver combining matching transmitter precoding,
the receivers having an amount of receiver antenna ports, and
a setting of the transmitter precoding being varied over frequency.

22. The apparatus of claim 21, wherein the setting of the transmitter precoding being varied over frequency induces frequency selectivity of the effective channel.

23. The apparatus of claim 21, wherein the setting of the transmitter precoding is varied over frequency independently of a frequency profile of the propagation channel.

24. The apparatus of claim 21, wherein a frequency interval between setting variations of the transmitter precoding is fixed, semi-established, or dynamically changing.

25. The apparatus of claim 24, wherein the frequency interval between setting variations of the transmitter precoding is shorter than a threshold value.

26. The apparatus of claim 24, wherein the frequency interval between setting variations of the transmitter precoding is an integer multiple of a system frequency unit.

27. The apparatus of claim 26, wherein the system frequency unit is a physical resource block or a sub-carrier bandwidth for orthogonal frequency division multiplex.

28. The apparatus of claim 24, wherein the frequency interval between setting variations of the transmitter precoding decreases when magnitude variance between frequencies of the propagation channel decreases.

29. The apparatus of claim 21, wherein the method further comprises transmitting the PAPR reduced MIMO signal over the propagation channel using the setting of the transmitter precoding.

30. The apparatus of claim 21, wherein the method further comprises determining the setting of the transmitter precoding.

31. The apparatus of claim 30, wherein a precoding basis spans a precoding space for the propagation channel, the precoding basis comprising a plurality of precoding basis components, and wherein the controlling circuitry is configured to cause determination of the setting of the transmitter precoding by causing the setting of the transmitter precoding to be a linear combination of the precoding basis components.

32. The apparatus of claim 31, wherein variation of the setting of the transmitter precoding comprises changing coefficient values for the linear combination of the precoding basis components.

33. The apparatus of claim 31, wherein the plurality of precoding basis components is larger than the number of MIMO layers and less than, or equal to, the amount of receiver antenna ports.

34. The apparatus of claim 31, the method further comprises determining the setting of the transmitter precoding by further causing determination of the precoding basis.

35. The apparatus of claim 34, wherein the controlling circuitry is configured to cause determination of the precoding basis by causing one or more of:
the plurality of precoding basis components to correspond to a plurality of strongest paths of the propagation channel;
the plurality of precoding basis components to correspond to a plurality of dominant modes of the propagation channel;
the plurality of precoding basis components to correspond to a plurality of singular vectors, with highest singular values, of the propagation channel; and
the plurality of precoding basis components to correspond to a plurality of eigenvectors of the propagation channel correlation matrix with highest eigenvalues.

36. The apparatus of claim 31, wherein the controlling circuitry is configured to cause determination of the setting of the transmitter precoding by further causing weighting of the setting of the transmitter precoding, wherein an average usage of one of the precoding basis components is associated with the relative strength of a corresponding propagation channel component.

37. The apparatus of claim 21, wherein a sequence used for variation of the settings of the transmitter precoding over frequency comprises one or more of:
a pre-defined sequence;
a pseudo-random sequence generated based on a seed value;
a sequence provided to corresponding receiver; and
a sequence negotiated with corresponding receiver.

38. The apparatus of claim 21, wherein the controlling circuitry is further configured to selectively apply the effective channel for null space projection only when the number of MIMO layers for the transmission is lower than the amount of receiver antenna ports.

39-43. (canceled)
